(19) United States
(12) Patent Application Publication
(10) Pub. No.: US 2014/0204190 A1
(43) Pub. Date: Jul. 24, 2014

(54) SYSTEMS AND METHODS FOR PROVIDING GUIDANCE FOR A PROCEDURE WITH A DEVICE

(71) Applicant: Allied Minds Devices LLC, Boston, MA (US)

(72) Inventors: Peter L. Rosenblatt, III, West Newton, MA (US); Omar Amirana, Boston, MA (US); David S. Park, Boston, MA (US); Thomas J. DiBartholomeo, Weston, CT (US); Paul S Jin, Newton, MA (US); Charles W. Wilson, Rutland, MA (US); Daniel J. Keldson, Quincy, MA (US)

(73) Assignee: Allied Minds Devices LLC, Boston, MA (US)

(21) Appl. No.: 13/946,173

(22) Filed: Jul. 19, 2013

Related U.S. Application Data
(63) Continuation of application No. 13/629,257, filed on Sep. 27, 2012.
(60) Provisional application No. 61/539,719, filed on Sep. 27, 2011.
(60) Provisional application No. 61/673,322, filed on Jul. 19, 2012.

(51) Int. Cl. G06Q 50/22; H04N 7/18; G06T 7/00

(52) U.S. Cl. CPC G06Q 50/22; G06T 7/0012; H04N 7/18
USPC 348/77; 705/2

(57) ABSTRACT

In embodiments, the present invention provides methods and systems for providing guidance for a procedure with a device. The methods and systems may include analyzing the procedure performed on a patient. The methods and systems may be enabled to track the device. The systems and methods may be enabled to protect the privacy of person.

### CROSS-REFERENCE TO RELATED APPLICATIONS

This application is a continuation of U.S. patent application Ser. No. 13/629,257 filed Sep. 27, 2012, which claims priority to U.S. Provisional Application Ser. No. 61/539,719, entitled INSTRUCT-OR, filed Sep. 27, 2011, and U.S. Provisional Application Ser. No. 61/673,322, entitled INSTRUCT-OR, filed Jul. 19, 2012. Each of these applications is hereby incorporated by reference in its entirety.

### BACKGROUND

1. Field

The methods, devices and systems disclosed herein relate to procedural guidance.

2. Description of the Related Art

Device manufacturers, such as medical device companies, devote considerable resources to the on-site support for usage of their devices, including providing on-site staff who are trained in the use of particular devices and can assist users, such as surgeons, in the use of such devices. The proliferation and complexity of modern devices has made this task increasingly difficult for the support specialists and increasingly costly for manufacturers. Telemedicine systems have been developed to provide remote instruction or teaching about new procedures and devices; however, a need exists for robust systems that reduce costs, ensure effective completion of procedures, and take advantage of emerging user interface capabilities, such as those presented on tablet computers.

### SUMMARY

Provided herein are methods and systems, alternatively referred to in some cases as “Instruct-ORs,” for supporting remote, specialized guidance of the use of devices and systems in an environment, such as an operating room, where guidance includes presenting a step-by-step workflow for a procedure on a user interface, such as a tablet computer, and providing a video communication connection to the remote specialist, such that a user can see all steps required for a procedure (optionally with supporting animation and video), interact with the specialist for further guidance, and complete a procedure. The methods and systems include a wide range of optional embodiments, such as for timing steps associated with a procedure, logging data associated with a procedure, and analyzing the data for a variety of purposes as further described herein.

In accordance with exemplary and non-limiting embodiments, the present disclosure provides a method of providing remote real-time guidance for a procedure with a device. In some embodiments, the method may include providing a user guidance application executing on a system during the procedure. In some embodiments, the system may be enabled to receive voice commands. In some embodiments, the method may include providing a step-by-step guidance from a remote human specialist through the steps required to complete the procedure with the device. In some embodiments, the method may include displaying on the system, procedure reference material associated with the procedure and accessible to the user to assist the user in the use of the device.

In some embodiments, the procedure may take place in an operating room.

In some embodiments, the procedure reference material may comprise at least one of text, audio, video, animations and still image content.

In embodiments, step-by-step guidance may comprise step-by-step training.

In some embodiments, the system may include at least one of a tablet device, a computer, a laptop, an audio/visual system, a mobile device, and a handheld device.

In some embodiments, the system may include at least one of a joystick a foot pedal, a microphone, a camera, a keyboard, virtual keyboard, headset, microphone enabled mask, voice recognition facility, and a voice command facility.

In some embodiments, the system may be adapted to provide at least one of text chat capability, audio chat capability, and video chat capability.

In some embodiments, the device may be at least one of a medical device, a telecommunications system device, a mechanical tool, a maintenance device, a diagnostic device, and chemical treatment device.

In accordance with exemplary and non-limiting embodiments, the present disclosure provides a procedure execution capture system for logging information. The procedure may include a voice command facility adapted to receive a voice command during a procedure using a device and to control the procedure execution system in response to the voice command. In some embodiments, the procedure may include an information associating facility for recording information during the procedure and associating the information with one or more steps undertaken in a workflow for the procedure. In some embodiments, the information may be time-stamped information about the steps undertaken during the procedure.

In some embodiments, the time stamped information may include data related to a medical procedure.

In some embodiments, the information may include contextual information about at least one of a patient, a user, the device, and the procedure.

In some embodiments, the system may include a medical device support communication system for providing an interaction between a practitioner performing the procedure with the device and a specialist having expertise in the use of the device. The device may include a live video communications facility enabled to provide a live video communication between the practitioner and the device specialist.

In some embodiments, the information may include status information of the one or more steps undertaken in a workflow for the procedure.

In some embodiments, the system may include a data analyzer facility to associate the time-stamped information with data associated with at least one of the outcome of the procedure, the duration of steps undertaken, a practitioner, a medical practice, and the device used.

In some embodiments, the system may include a feedback system to improve at least one of a medical device, a medical procedure, a medical practitioner, and a medical practice.

In accordance with exemplary and non-limiting embodiments, the present disclosure provides a support communication system for providing an interaction between a user and a specialist having expertise in a device. The system may include a live video communications facility enabled to provide a live video communication. The system may include a tablet interface presenting the video communications facility, a workflow associated with the device, and content related to the usage of the device. In some embodiments, the live video communication may include an interaction between the user and the specialist during the procedure for assisting the user in completing the workflow.

In embodiments, the system may include a privacy system. The privacy system may include a video capture facility to encode and decode live video. In some embodiments, the privacy system may include an obfuscation facility to modify the live video by obfuscating a person's identity. In some embodiments, the privacy system may include an obfuscated video communication facility to communicate the modified live video.

In some embodiments, the live video communication may include a live text, audio and video communication.

In some embodiments, the workflow may be a medical procedure and said workflow may be stored in one of a cloud or in a server in a hospital.

In some embodiments, the support communication system may comprise a mask worn by the user wherein said mask comprises a mask communications facility to connect the mask to another device. In some embodiments, the mask may comprise a microphone adapted to receive and transmit voice commands for communication between the user and specialist. In some embodiments, communication between the user and specialist may be via said another device.

In accordance with exemplary and non-limiting embodiments, the present disclosure provides a procedure guidance system for training of a procedure and/or guiding use of a device in an environment. The procedure may include a practitioner interface device. The practitioner interface device may include a touch screen, and a video chat capability. In some embodiments, the procedure may include an application executing on the system that provides step-by-step guidance in the use of the device via the procedural guidance system. In some embodiments, the procedure may include a procedure execution capture system for logging time-stamped information related to a procedure using the device. In some embodiments, the procedure may include a specialist support facility for enabling a live video interaction with a specialist for the device.

In some embodiments, the environment may be an operating room.

In some embodiments, the practitioner interface device may be comprised of a foot pedal.

In some embodiments, the practitioner interface device may include a joystick.

In some embodiments, the practitioner interface device may include an audio input device.

In some embodiments, the video chat capability may be a text chat capability.

In some embodiments, the video chat capability may be a text chat capability.

In some embodiments, providing step-by-step guidance includes providing step-by-step training.

In some embodiments, the procedural guidance system may be one of a tablet device, a computer, a laptop, an audio/visual system, a mobile device, or a handheld device

In some embodiments, the time-stamped information may include procedural data.

In accordance with exemplary and non-limiting embodiments, the present disclosure provides method of providing real-time guidance on the use of a medical device in an operating room. The method may include providing a practitioner guidance application executing on a system and the application may be enabled to receive voice commands. In some embodiments, the method may include providing a step-by-step guidance through the steps required to complete a medical procedure utilizing the medical device. The method may include displaying on the system medical device reference material associated with a medical device and accessible to a medical practitioner to assist the medical practitioner in the use of the medical device.

In some embodiments, displaying reference material may include displaying one or more of still images and video.

In accordance with exemplary and non-limiting embodiments, the present disclosure provides a procedure execution capture system for logging information. The procedure may include a voice command facility adapted to receive a voice command and to control the procedure execution system in response to the voice command. In some embodiments, the procedure may include an information associating facility for associating the information with the steps undertaken in a workflow for a medical procedure. In some embodiments, the method may include that the information may be time-stamped information about the steps undertaken during a medical procedure using a medical device.

In accordance with exemplary and non-limiting embodiments, the present disclosure provides a medical device support communication system for providing an interaction between a practitioner performing a medical procedure with a medical device and a specialist having expertise in the use of a medical device. The system may include a live video communications facility enabled to provide a live video communication between the practitioner and the device specialist.

In some embodiments, the live video communication may comprise a live text, and/or live audio communication. In some embodiments, the communication may be not be live.

In accordance with exemplary and non-limiting embodiments, the present disclosure provides a medical device support communication system for providing an interaction between a practitioner performing a medical procedure with a medical device and a specialist. The system may include a step-by-step workflow associated with the medical device. The system may include workflow status information associated with the step-by-step workflow of the medical procedure being performed. In some embodiments, the system may include a specialist support system enabled to receive workflow status information before the specialist interacts with the practitioner. In some embodiments, the system may include a live video communications facility enabled to provide a live video communication between the practitioner and the specialist.

In some embodiments, the live video communication may comprise a live text, and live audio communication. In some embodiments, the communication may not be live.

In accordance with exemplary and non-limiting embodiments, the present disclosure provides an analytic system for analyzing time-stamped information about steps undertaken during a medical procedure using a medical device on a patient. The system may include an information communication facility to receive time-stamped information about steps undertaken during the medical procedure. In some embodiments, the system may include a data analyzer facility to associate the time-stamped information with a step undertaken in a workflow for the medical procedure with data associated with at least one of the outcome of the procedure, the duration of steps undertaken, the practitioner, the practice, the medical device. The system may ensure that the system can query the user for specific feedback or relevant information.

In accordance with exemplary and non-limiting embodiments, the present disclosure provides a feedback system. The feedback system may improve at least one of a medical device, a medical procedure, a medical practitioner, and a medical practice. The feedback system may include an information logging facility to log time-stamped information about steps undertaken during at least one medical procedure by a medical practitioner using a medical device on a patient. The feedback system may include a procedure logging facility to log time-stamped information about steps undertaken during at least one procedure by a user using a medical device on a patient. The feedback system may include a procedure information comparison facility to compare the time-stamped information with at least one of information from other medical procedures using the medical device, information from another medical procedure using another medical device, information from other medical procedures undertaken by another medical practitioner, and information from another procedure by the medical practitioner. The feedback system may include a feedback generating facility to, based on the comparison of the information, provide feedback to at least one of the manufacturer of the medical device, the manager of the medical procedure and the medical practitioner.

In some embodiments, the feedback to the medical practitioner may include the total procedure time.

In some embodiments, the feedback to the medical practitioner may include the time for each step of the procedure.

In accordance with exemplary and non-limiting embodiments, the present disclosure provides a medical procedure guidance platform for guiding use of a medical device in an operating room. The procedure may include a practitioner interface device. The practitioner interface device may include an interactive mechanism and an interface adapted to receive voice commands. The procedure may include a video chat capability. In some embodiments, the procedure may include a plurality of stored medical procedure workflows related to a medical device. In some embodiments, the procedure may include a procedure execution capture system for logging time-stamped information related to a medical procedure workflow on a step-by-step basis.

In some embodiments, the interactive mechanism may be a touch screen.

In some embodiments, the interactive mechanism may be a foot pedal.

In some embodiments, the interactive mechanism may be a microphone

In some embodiments, a stored medical procedure may be stored in one of a cloud or in a server in a hospital.

In accordance with exemplary and non-limiting embodiments, the present disclosure provides a medical procedure guidance platform for guiding use of a medical device in an operating room. The procedure may include a practitioner interface device. The practitioner interface device may include a touch screen and an interface adapted to receive voice commands. In some embodiments, the procedure may include a video chat capability. In some embodiments, the procedure may include a plurality of stored medical procedure workflows related to a medical device. The procedure may include a procedure execution capture system for logging time-stamped information related to a medical procedure workflow on a step-by-step basis. In some embodiments, the procedure may include a voice command security system to manage voice control within the operating room by enabling a security protocol for voice control of the system.

In some embodiments, a stored medical procedure may be stored in one of a cloud or in a server in a hospital.

In accordance with exemplary and non-limiting embodiments, the present disclosure provides a support specialist notification system. The system may include a messaging facility that sends an automated message to a support specialist for a medical device. The message indicates that a medical procedure has been initiated using a medical device supported by the support specialist. The message provides contextual information about the medical procedure.

In some embodiments, the message indicates that a medical procedure has been completed.

In accordance with exemplary and non-limiting embodiments, the present disclosure provides a medical device tracking system. The system may include device tracking facility to receive a communication from a tracked medical device. In some embodiments, the system may include a tracked medical device. In some embodiments, the tracked device may include a tracking communication facility to initiate communication when the packaging for a medical device may be opened in proximity to the device tracking facility.

In some embodiments, the device tracking facility may be adapted to receive a communication from a tracked medical device packaging.

In accordance with exemplary and non-limiting embodiments, the present disclosure provides a method of routing of support requests to support specialists for medical procedures. The method may include transmitting a request to a support specialist and identifying a support specialist based on any one or more of (a) information about the capabilities of available support specialists and (b) status data about any one or more of (i) procedures currently being undertaken and (ii) procedures currently being supported.

In accordance with exemplary and non-limiting embodiments, the present disclosure provides a method of providing a remote controlled augmented reality. The method may include providing a communication interface between a surgical location and a remote location. The method may comprise augmenting a view within the surgical location with an augmented reality facility. The method may include providing control of the augmented reality facility from the remote location.

In accordance with exemplary and non-limiting embodiments, the present disclosure provides a method for operating a tablet in an operating room. The method may include providing a voice command interface associated with a tablet in an operating room to receive voice commands. The method may include operating the tablet in response to a voice command received by the voice command interface.

In some embodiments, the voice command interface may comprise using a microphone.

In some embodiments, the voice command interface may comprise a foot pedal.

In accordance with exemplary and non-limiting embodiments, the present disclosure provides a method for uploading a medical device guidance application to a server. The method may include storing a medical device guidance application on a medical device. The method may include connecting the medical device in use in a medical procedure to a server. The method may include transmitting the medical device guidance application from the medical device to the server.

In accordance with exemplary and non-limiting embodiments, the present disclosure provides a mask. The mask may include a shield to cover a wearer of the mask and attachable to the head of the wearer. In some embodiments, the mask may include a mask communications facility to connect the mask to another device. In some embodiments, the mask may include a microphone adapted to receive voice commands.

In some embodiments, the mask communication facility may connect the mask to another device over a wire.

In some embodiments, the mask communication facility may connect the mask to another device wirelessly.

In some embodiments, the microphone may be adapted to transmit voice commands.

In accordance with exemplary and non-limiting embodiments, the present disclosure provides a operating room server that may be adapted to drive the operation of one or more system component devices. The serve may include a cloud communication facility to connect between the operating room server and a cloud network. In some embodiments, the server may include a device communication facility to connect between the operating room server and a device.

In accordance with exemplary and non-limiting embodiments, the present disclosure provides a privacy system. The privacy system may include a video capture facility to encode and decode live video. The privacy system may include an obfuscation facility to modify the live video by obfuscating a person's identity. In some embodiments, the system may include an obfuscated video communication facility to communicate the modified live video.

In accordance with exemplary and non-limiting embodiments, the present disclosure provides a system for guiding a user in an operational environment. In some embodiments, the system may include a tablet with touch screen, chat capability, and an application for providing step-by-step guidance. In some embodiments, the system may include a system for logging information about steps undertaken during an operational procedure. The system may include a communications system for enabling live interaction with a support specialist.

In some embodiments, the chat capability may comprise one or more of a text chat capability, an audio chat capability, and a video chat capability.

In some embodiments, the step-by-step guidance may be a step-by-step guidance in the use of a device.

In some embodiments, the step-by-step guidance may be a step-by-step guidance in the performance of a procedure.

In some embodiments, logging information may comprise logging time-stamped information.

In some embodiments, the steps undertaken during an operational procedure may comprise steps undertaken during an operational procedure using a device.

In some embodiments, the device may be at least one of a medical device, a telecommunications system device, a mechanical tool, a maintenance device, a diagnostic device, and chemical treatment device.

### BRIEF DESCRIPTION OF THE FIGURES

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 depicts methods and systems for assisting a practitioner in the use of a medical device to perform a procedure on a patient.

FIG. 2 depicts a block diagram of a tablet device of a procedure instruction system.

FIG. 3 depicts various data, data types, and data storage associated with a procedure instruction system.

FIG. 4 depicts an embodiment of a procedure instruction system.

FIG. 5 depicts aspects of a procedure instruction system associated with live video interaction with a specialist.

FIG. 6 an alternate embodiment of a procedure instruction system that includes deployment across a cloud-based network environment.

FIG. 7 depicts a specialist support routing capability.

FIG. 8 depicts augmented reality associated with a procedure instruction system.

FIG. 9 depicts a standalone variant of a procedure instruction system.

FIG. 10 depicts a typical deployment of a procedure instruction system in a procedure environment that is embodied as an operating room.

FIG. 11 depicts a real-time display variant of a procedure instruction system.

FIG. 12 depicts a representative image of a procedure instruction.

FIG. 13 depicts a bar graph of time for performing steps in a procedure.

FIG. 14 depicts a display of aggregated procedure performance time data.

FIG. 15 depicts a network of procedure instruction systems connected to a scheduler.

FIG. 16 depicts a method of updating a procedure instruction system.

FIG. 17 depicts a flowchart of interactions with a procedure instruction system.

FIGS. 18-19 depict interfaces of a procedure instruction system.

FIG. 20 depicts an example of analytics of the system.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting, but rather to provide an understandable description of the invention.

A medical procedure instruction system may provide significant benefits in providing medical services. Such a system may provide immediate and updated training and re-enforcement of procedures for medical device use, especially rarely used medical devices. With consistent procedure instructions, procedure outcomes will be more consistent thereby protecting the reputation of the practitioner, the medical device provider, the hospital, and the like. The availability of rich, real-time Point Of Care (POC) analytics from a potentially large field of deployed systems could revolutionize the medical device and/or procedure refinement process while ensuring robust data security, and patient confidentiality. Even by enabling direct real-time practitioner to device support specialist (e.g. sales rep) connectivity, tips learned by the support specialist from a procedure performed a few hours earlier across the country can be shared with a practitioner for maximum benefit. By deploying such a procedure instruction system using the latest technology including open platform technology, ongoing support, ease of integration, and extensibility of the system will benefit significantly.

In embodiments, methods and systems of a procedure instruction system may be enabled to guide a practitioner host to use a medical device in a procedure environment, where the procedure instruction system may be comprised of a tablet device, a system for logging time stamp data about steps undertaken during a procedure using the medical device on a patient, and a communication system. The medical device may be a stent, a shunt, a catheter, a delivery device, an implant, a vascular assist device, a pump, a monitoring device, an imaging device, a prosthetic or some other medical device. The procedure environment may be an operating room, an emergency room, catheterization laboratory, a GI procedure suite, a post-anesthesia care unit, an intensive care unit, a CT suite, an MRI suite, a scrub station, a learning lab, a doctor's office or some other environment. The time stamp data may include logged information regarding a medical procedure, such as, but not limited to a start time stamp for a medical procedure, a start time stamp for each step in a medical procedure, an end time stamp for each step in a medical procedure, an end time stamp for a medical procedure, and other logged information with a time stamp.

In some embodiments, the tablet device may be comprised of a touch screen/display, a video chat facility, and an application. In one embodiment, the video chat facility may be comprised of a camera and software for encoding and decoding video. In one embodiment, the touch screen/display is adapted to accept input using a stylus. In another embodiment, the touchscreen is adapted to accept input using a virtual keyboard. The touchscreen may also be adapted to accept input from a hand, such as, but not limited to, a press, a movement, gestures with multiple fingers, and other inputs. In embodiments, the application may be an application for providing step-by-step guidance in the use of the medical device. For example, the application may provide step-by-step guidance from a directions for use (a “DFU”) or from an instructions for use (an “IFU”) for utilizing the medical device. In some embodiments, the step-by-step guidance may also include audio and video elements. The audio element of the step-by-step guidance may be audio narrating the steps of the step-by-step guidance. The video element of the step-by-step guidance may be video displaying each action to be taken for each step of the step-by-step guidance. The step-by-step guidance may also include text. For example, the step-by-step guidance may include text from an associated DFU, which text may be displayed by the procedure instruction system, based on an input from the practitioner host. In some embodiments, the step-by-step guidance may include optional steps that may be, for example, modified, reordered, and/or deleted. In another embodiment, the step-by-step guidance may be modified by permitting the practitioner host to insert one or more additional steps.

In some embodiments, the communication system may enable an interaction with a specialist. The interaction with the specialist may be a live video interaction between the practitioner host and the specialist. The purpose of the interaction may be for the practitioner host to obtain additional information and/or guidance from the specialist. For example, if the practitioner host discovers a new condition in the patient or has a question regarding an optional step relating to the procedure using the medical device, the practitioner may demonstrate such to the specialist via the live video interaction and receive guidance from the specialist regarding how to proceed with the procedure.

In embodiments, the system may also include a system for monitoring and providing feedback based on one or more of the location, position, angle, and movement of the medical device, and/or one or more of the location, gesture, position, angle and movement of the host practitioner. The system for monitoring and providing feedback may be comprised of a camera, like the Kinect for the Xbox-360 or the PS3 Move. In some embodiments, the system for monitoring and providing feedback may be comprised of a c-arm.

In embodiments, the application may be configured to provide real-time guidance for the use of a medical device. In some embodiments, the real-time guidance for the use of a medical device may comprise step-by-step navigation through the steps required to complete a procedure and reference materials accessible to a practitioner host to aid in the use of the medical device. In some embodiments, the application may be enabled to receive voice commands.

In some embodiments, the system, device, and methods may include a display available in an environment such as an operating room or other environment for assisting a user in recalling a sequence of steps, or the optimal sequence of steps to perform a procedure, such as a medical or surgical procedure. In embodiments, the device may comprise one or more of several possible configurations which may comprise a tower having a central unit, such as a computer, a flat screen monitor, speakers for narration of steps and the like. In embodiments, the device may comprise a remote controlled by the user or others to advance to the next step or go to previous steps, and the like. In some embodiments the remote may be disposable or reusable, and may be controlled with either a foot pedal or hand activated, and it may be wireless or tethered in various embodiments. Configurations may comprise various examples as described further herein. In some embodiments, a program for the system may be available on a hand-held device such as an iPad. By way of example, if a user, or surgeon, wants to perform a suburethral sling for stress urinary incontinence, the surgeon, the operating room staff, and the like may choose the specific procedure or sling from a menu of various procedures that are programmed into the device, stored on a server, in the cloud, and the like. In embodiments, any procedure performed in a particular environment, such as an operating room, may be available on the system.

By way of further example, the systems, and methods may use a device as described herein in a procedure such as a sling procedure. In embodiments, the staff, or a user may choose “TVT-O”, a commercially available transobturator sling from Ethicon Women's Health & Urology. In some embodiments, the steps may be included in the program, and in some embodiments, all 27 steps may be listed with short titles, in DVD format. In some embodiments, when the step is chosen, the menu item may be enlarged, and other steps may still be listed, for example on the side of the display. In some embodiments, each step may include a photo, diagram, video, animation, and the like that may demonstrate or provide information about a specific step. In some embodiments, a visual step may be accompanied with text, or subtitles explaining the step, audio narration of the step, both, and/or other features as described herein. By way of example only, and not to limit the invention, the steps of the TVT-O example noted above may comprise: 1. Patient placed in high dorsal lithotomy position; 2. Foley catheter inserted and placed to drainage; 3. Marking pen used to establish landmarks (which may include a description of mark placement); 4. Local anesthesia used to anesthetize inner thigh skin and epithelium of mid urethra and paraurethral areas; 5. Local anesthesia injected into medial portion of obturator foramen; 6. Allis clamps placed 1 cm proximal to external urethral meatus, and at level of bladder neck; 7. 1.5 cm incision made along mid-portion of the urethra; 8. Allis clamp placed on one edge of incision and Metzenbaum scissors used to sharply and bluntly dissect paraurethral space until underside of descending ischiopubic ramus is reached; 9. With Metzenbaum scissors pointed at 45 degree angle and with scissor handle pushed up against contralateral buttocks, firm but controlled pressure on scissors perforates the obturator membrane; 10. Winged guide placed just behind scissors and advanced through obturator membrane; 11. Helical needle placed within winged guide with handle at slight angle (hand position may be displayed); 12. Helical needle pushed laterally though obturator membrane; 13. Winged guide removed; 14. Handle of helical needle dropped vertically while curved needle is brought around ischiopubic ramus and out through medial thigh Skin incision may be made to assist with needle perforation through skin; 15. Needle withdrawn partially while holding on to proximal portion of white needle cover; 16. Kelly clamp grasps white needle cover end; 17. Helical needle completely withdrawn and disposed; 18. White needle cover pulled through skin and Kelly replaced on mesh with plastic sleeve; 19. White needle cover cut off with scissors; 20. Allis clamp on side is replaced on Contralateral side; 21. Procedure repeated on Contralateral side with attention to laying the mesh flat without twists; 22. Cystoscopy performed with 300 cc in the bladder to assure bladder integrity; 23. Foley catheter replaced after cystoscopy and before sling tensioning; 24. Sling tension adjustment performed (e.g. Metzenbaum between mesh and urethra, Babcock technique) and plastic sleeves removed; 25. Vaginal incision closed with running absorbable suture; 26. Sling arms cut just below level of skin; 27. Dermal glue or fine interrupted suture placed on thigh incisions. In embodiments, the surgeon may have the option of viewing a more detailed DFU/IFU, and/or a more detailed explanation of each step. In some embodiments, there may be a set of frequently asked questions and an area to “troubleshoot” based on key words and/or phrases. In embodiments, the surgeon may be able to access immediate technical support through the system for questions or problems with a medical device. In embodiments, reporting mechanisms for complications experienced may also be available. In some embodiments, the device may be a capital expense for hospitals, and/or the data contained on the system may be updatable, and medical device manufactures may have the option to participate in the system for both a set-up charge as well as a subscription price, and the like.

The step-by-step navigation through the steps required to complete a procedure may be from a DFU or from an IFU for utilizing the medical device. The step-by-step navigation through the steps required to complete a procedure may also include audio and video elements. The audio element of the step-by-step navigation through the steps required to complete a procedure may be audio narrating the steps of the step-by-step navigation. The video element of the step-by-step navigation through the steps required to complete a procedure may be video displaying each action to be taken for each step of the step-by-step navigation. In some embodiments, the step-by-step navigation through the steps required to complete a procedure may include optional steps that may be, for example, modified, reordered, and/or deleted. In another embodiment, the step-by-step navigation through the steps required to complete a procedure may be modified by permitting the practitioner host to insert one or more additional steps.

The reference materials accessible to a practitioner host to aid in the use of the medical device may be text descriptions of the step-by-step navigation. For example, the step-by-step navigation may include text from an associated DFU, which text may be displayed by the procedure instruction system, based on an input from the practitioner host.

In embodiments, methods and systems of a procedure instruction system may be enabled to log time stamp data about steps undertaken during a medical procedure using a medical device on a patient and associating the time stamp data with the steps undertaken in a work flow for the medical procedure. In some embodiments, the procedure instruction system may be enabled to receive voice commands. A procedure instruction system may log time stamp information based on one or more voice commands received by the procedure instruction system.

The time stamp data may include logged information, such as, but not limited to a start time stamp for the medical procedure, a start time stamp for each step in the medical procedure, an end time stamp for each step in the medical procedure, an end time stamp for the medical procedure, a start time stamp for an interaction with a specialist during the medical procedure, an end time stamp for an interaction with a specialist during the medical, and other logged information with a time stamp.

In embodiments, methods and systems of a procedure instruction system may be comprised of a communication system that may be enabled to provide a live video interaction between a practitioner host performing a medical procedure with a medical device on a patient and a specialist for the medical device. For example, during the medical procedure, the practitioner host may use the procedure instruction system to connect with the specialist to ask a question that the practitioner host has regarding the medical device or the medical procedure by demonstrating the question in a live video. In this example, the specialist may, in real time, view the live video from the practitioner host and respond to the practitioner hosts' question and demonstrate the proper use of the medical device in the medical procedure.

In some embodiments, the live video interaction may include providing, by the practitioner host, one or more still images relating to the procedure to the specialist. In some embodiments, providing a still image may include sending the specialist an image file in a format such as a JPEG, TIFF, RAW, PNG, GIF, BMP, SVG, or some other format. For example, the practitioner host may send the specialist a radiographic image or a biometric image, such as an EKG tracing, to enrich the procedure instruction.

In embodiments, methods and systems of a procedure instruction system may be comprised of a communication system that may be enabled to provide a live video interaction between a practitioner host performing a medical procedure with a medical device on a patient and a specialist for the medical device, and to provide the specialist with a prepopulated information. For example, during the medical procedure, the practitioner host may use the procedure instruction system to connect with the specialist to ask a question that the practitioner host has regarding the medical device or the medical procedure by demonstrating the question in a live video. In this example, the specialist may, in real time, view the live video from the practitioner host and respond to the practitioner hosts' question and demonstrate the proper use of the medical device in the medical procedure.

In some embodiments, the communication system may be associated with a step-by-step workflow for using the medical device in the medical procedure. In an embodiment, the step-by-step workflow for the medical device may be a step-by-step workflow from a DFU or from an IFU for utilizing the medical device. The step-by-step workflow may be generated using a content creation tool. In embodiments, the content creation tool may be comprised of (a) an interface that may define one or more branches in the step-by-step workflow, (b) one or more of: (x) an interface for creating one or more video/animation, and (y) an interface for creating other media (e.g. audio track, text, etc.) for the step-by-step workflow, and (c) an interface for displaying one or more models (e.g. CAD models).

In some embodiments, the prepopulated information may be associated with the step-by-step workflow for the medical device. The prepopulated information provided to the specialist may be comprised of information regarding the type of medical procedure, information regarding the current step in the step-by-step workflow, information regarding optional steps added, modified or removed by the practitioner host, time stamp information regarding one or more steps in the step-by-step workflow, and other information that may be useful for the specialist in order to support the practitioner host.

In some embodiments, an analytic system may be provided for analyzing time stamped information about steps taken during a medical procedure using a medical device on a patient and associating the time stamped information with the steps taken in a workflow for the medical procedure with data associated with at least one of the outcome of the procedure, the duration of steps undertaken, the practitioner host, the medical practice, and the medical device. In one embodiment, the analytic system may be utilized by one or more of a medical practice, a host practitioner, an insurance company, an instructor, a specialist, and a device manufacturer host in order to analyze one or more of the host practitioner, the medical procedure, and the medical device. For example, the practitioner host may be a medical student using the methods and systems of a procedure instruction system in a cadaver lab and the analytic system may be used by the medical student's instructor in order to analyze the medical student's performance of the medical procedure. The analysis of the time stamped information may include aggregating, averaging and/or comparing the amount of time one or more practitioner hosts spends on one or more steps in a medical procedure. The analysis of the time stamped information may also be used by a medical device manufacturer host for the purpose of one or more clinical trials associated with a medical device. The analysis of the time stamped information may be used by the host practitioner to review the host practitioner's performance of a medical procedure in order to improve the results of the host practitioner's future performance of the same medical procedure. In some embodiments, the medical practice may be a medical practice within a hospital.

In some embodiments, the methods and systems of procedure instruction may include a feedback system for improving at least one of a medical device, a medical procedure, a practitioner host, and a medical practice, including logging time stamped information about steps taken during at least one medical procedure by a practitioner host using a medical device on a patient; comparing the time stamped information with at least one of (i) information from other procedures using the medical device, (ii) information from procedures using other medical devices, (iii) information from procedures by the steps undertaken by other practitioner hosts, and (iv) information from other medical procedures by the practitioner host; and based on the comparison, providing feedback to at least one of the medical device manufacturer host, the manager of the medical procedure, and the practitioner host. In one embodiment, the practitioner host may be a medical student and the feedback may be provided to an instructor. In one embodiment, the feedback may be provided to a medical practice, such as a hospital. The feedback provided by the feedback system may be accessed by the medical device manufacturer host. For example, the medical device manufacturer host may review the feedback in order to improve design of the next generation of a medical device.

In some embodiments, the feedback system may be enabled to receive additional information. In one embodiment, the feedback system may be enabled to receive information from a patient regarding at least one of the medical device and the practitioner host. For example, the patient may provide the feedback system with a complaint relating to pain from an implanted medical device or regarding post-operative maintenance of the medical device. The feedback system may also be enabled to receive information from a practitioner host regarding the steps in the medical procedure or the medical device. For example, the practitioner host may recommend adding one or more steps to the medical procedure or comment that the medical device is difficult to use for left-handed surgeons. The feedback system may be enabled to receive information from a specialist regarding the steps in the medical procedure or the medical device. For example, the specialist may recommend that one or more steps in the medical procedure be skipped by the practitioner hosts if a patient has a certain condition.

In embodiments, the methods and system of procedure instruction may include a platform that may be comprised of a touch screen/display interface in a procedure environment with a voice control, a video communications capability, a plurality of stored workflows for medical procedures, and a system for logging and tracking of time stamped data regarding a medical procedure on a step-by-step basis. In one embodiment, the touch screen/display is adapted to accept input using a stylus. In another embodiment, the touchscreen is adapted to accept input using a virtual keyboard. In other embodiments, the touchscreen is adapted to accept input from a hand, such as, but not limited to, a press, a movement, gestures with multiple fingers, and other inputs. The voice control may receive voice commands from one or more practitioner hosts. The voice commands may be associated with one or more of the stored workflows for medical procedures. For example, the voice commands may instruct the platform to proceed to the next step in the workflow, or instruct the platform to replay a step in the workflow. The voice commands may also be associated with controlling the platform. For example, a voice command may instruct the platform to begin a video communication between a practitioner host and a specialist. In an embodiment, the plurality of stored workflows for medical procedures may be a plurality of step-by-step workflows from one or more of a DFU for utilizing the medical device and an IFU for utilizing the medical device.

In some embodiments, the video communications capability may be comprised of a camera and software for encoding and decoding video. The video communications capability may enable an interaction with a specialist. The interaction with the specialist may be a live video interaction between the practitioner host and the specialist.

The system for logging and tracking of time stamped data regarding a medical procedure may be enabled to log and track information regarding a medical procedure, such as, but not limited to a start time stamp for a medical procedure, a start time stamp for each step in a medical procedure, an end time stamp for each step in a medical procedure, an end time stamp for a medical procedure, and other logged information with a time stamp.

In embodiments, the methods and system of procedure instruction may include a platform that may be comprised of a touch screen/display interface in a procedure environment with a voice control, a video communications capability, a plurality of stored workflows for medical procedures, a system for logging and tracking of time stamped data regarding a medical procedure on a step-by-step basis, and a system for managing voice control within the procedure environment by enabling a security protocol for voice control of the platform. In one embodiment, the touch screen/display is adapted to accept input using a stylus. In another embodiment, the touchscreen is adapted to accept input using a virtual keyboard. In other embodiments, the touchscreen is adapted to accept input from a hand, such as, but not limited to, a press, a movement, gestures with multiple fingers, and other inputs. The voice control may receive voice commands from one or more practitioner hosts. The voice commands may be associated with one or more of the stored workflows for medical procedures. For example, the voice commands may instruct the platform to proceed to the next step in the workflow, or instruct the platform to replay a step in the workflow. The voice commands may also be associated with controlling the platform. For example, a voice command may instruct the platform to begin a video communication between a practitioner host and a specialist. In an embodiment, the plurality of stored workflows for medical procedures may be a plurality of step-by-step workflows from one or more of a DFU for utilizing the medical device and an IFU for utilizing the medical device.

In some embodiments, the video communications capability may be comprised of a camera and software for encoding and decoding video. The video communications capability may enable an interaction with a specialist. The interaction with the specialist may be a live video interaction between the practitioner host and the specialist.

A system for logging and tracking of time stamped data regarding a medical procedure may be enabled to log and track information regarding a medical procedure, such as, but not limited to a start time stamp for a medical procedure, a start time stamp for each step in a medical procedure, an end time stamp for each step in a medical procedure, an end time stamp for a medical procedure, and other logged information with a time stamp.

In some embodiments, a system for managing voice control within the procedure environment by enabling a security protocol for voice control of the platform may be enabled to receive voice commands from one or more practitioner hosts. This system may be further enabled to recognize voice commands from specific practitioner hosts. This system, in response to one or more voice commands, may begin a secure mode of operation in which it will only respond to the voice commands from one or more specific practitioner hosts that this system recognizes as authorized to operate the platform in secure mode.

In some embodiments, methods and systems of a procedure instruction system may be enabled to send an automated message to a medical device specialist indicating that a medical procedure has been initiated using a medical device supported by the specialist and where the message provides contextual information about the medical procedure. In some cases, the messages may be sent upon the initiation of medical procedure. However, the messages may be sent at other times and/or upon other events. For example, the automated message may be sent as a report at the beginning of the day listing the procedures scheduled for that day. The automated message may be one or more of a text message, an SMS message, an instant message, an email, an invitation for a video communication or some other type of message. The contextual information about the medical procedure may be comprised of a start time stamp, an estimated completion time, an address, data regarding the practitioner host, data regarding the patient, the medical device, and some other relevant contextual information about the medical procedure.

The medical device may comprise an embedded communication facility that initiates communication with a tracking system in response to opening the packaging for the medical device in proximity to the tracking system. The embedded communication facility may be one or more of a chip, another device, and software. The communication facility may communicate via one or more of radio communication, RFID, SMS message, Bluetooth, Wi-Fi network, near field communication, and some other communication method. The device may also include a movement detection facility, such as, for example, an accelerometer or an asset tracking system. Devices including a movement detection facility may wake up in response to detecting a movement of the device and, upon waking up, notify the tracking system that the device has been moved. For example, the device may be placed in a storage closet and the movement detection facility may wake up the device when a nurse removes the device from storage, in preparation for use in a surgery. In another example, the movement detection facility may wake up the device in response to detecting that the device has been moved farther than 5 feet from the storage closet.

The tracking system, in response to the communication with the medical device, may provide an update to one or more systems to which it connects. For example, the tracking system may provide a notice the relevant hospital system that the supply of medical devices is low so that the hospital may order more. In another example, the tracking system may provide a notice to the device manufacturer so that the manufacturer invoices the hospital for the device. In a non-medical example, the device may be a milk carton and the movement detection facility may, in response to detecting that the milk carton has been thrown away, update an online shopping list by adding milk to the shopping list.

In some embodiments, the methods and system of procedure instruction may include a specialist support routing system that is enabled to provide routing of support requests to live specialists for medical procedures based on information about the capabilities of available specialists and status data about at least one of (i) medical procedures currently being undertaken and (ii) medical procedures currently being supported. A procedure instruction system may communicate with a specialist support routing system via one or more of a cloud or network. The specialist support routing system may be owned by a medical device manufacturer host and provided to coordinate support for the practitioner hosts. The requests to live specialists may be invitations for a live video interaction. In response to a request for support from a practitioner host, the specialist support routing system may use the information about the capabilities of available specialists and the status data to identify the next available specialist available and capable of supporting the practitioner host that submitted the request for support. Based on the identification of the next available specialist, the specialist support routing system may initiate a live video interaction between the practitioner host and the specialist.

In some embodiments, the methods and systems of procedure instruction disclosed herein may include an augmented reality capability that may aid a practitioner performing a procedure. The system may provide a communications interface between surgical location and a remote location, augmenting a view within the surgical location with an augmented reality facility and providing control of the augmented reality facility from the remote location. The augmented reality capability may provide a view of a procedure step or instruction overlaid on a real-time view of the procedure being performed. The practitioner may be able to view, such as through an augmented reality optical system (e.g. augmented reality glasses), the actual device being used in the actual procedure that he/she is performing with augmentation superimposed to aid in the delivery of the procedure with the medical device. In an example, the practitioner may be using a medical device that has a point of adjustment. The practitioner may view the actual device point of adjustment with an augmented reality overlay that provides indications as to how to perform adjustment of the device (e.g. which way to turn a knob). This capability may be enhanced by providing remote control of the augmented reality elements being presented to the practitioner. Control may be turned over to a specialist (e.g. a medical device technical support specialist) who may view the same actual real-time view of the actual device as the practitioner sees. In such a scenario, the specialist may control the augmentation of the reality displayed for the practitioner. To prepare the augmentation, the specialist may use the capabilities and interfaces between a specialist and a procedure instruction system as described elsewhere herein including data pre-population, real-time video conferencing, an analytic framework, and the like. In another example, the specialist may receive the same view of the device and/or procedure patient as the practitioner via video transmitted from a procedure instruction system over a network (e.g. a cloud-based network, the Internet, and the like). The specialist may control overlaying of augmented reality that addresses any aspect of use of the medical device and/or of the procedure from a remote location. Because the specialists may be in audio and video communication with the practitioner, the specialist may here the conversation occurring between the practitioner and assistants and may control the augmented reality to address a concern or other aspects of the procedure that the specialists determines from the conversation. Likewise, the practitioner host may ask the specialist a question in the specialist may control the augmented reality responses to the practitioner.

The methods and systems of procedure instruction disclosed herein may include the capability to operate portions of the procedure instruction system, such as the tablet device, solely with voice commands provided by the practitioner or some assistant in the procedure environment. This may substantially free up the practitioner from having to manually control any aspects of the procedure instruction system thereby allowing him or her to provide full attention to the procedure and patient. The procedure instruction system may include voice recognition and or voice-based command interpretation capabilities. Alternatively the procedure instruction system may rely on a cloud-based voice recognition and command interpretation system to provide commands and control of the various aspects of the procedure instruction system. In one example the tablet device may include a voice recognition capability that may recognize one or more voices of participants in an operating room and interpret those voices to determine commands for the system and ignore other audio input such as instructions between a practitioner and an assistant. The methods and systems procedure instruction disclosed herein may be controlled by such speech recognition capabilities.

The medical device may be comprised of a networking facility and an application, and may be enabled to communicate one or more of an application and a step-by-step workflow stored in the application to a procedure instruction system when a medical procedure that uses the medical device is initiated. In some embodiments, the medical device communicates with the server. The networking facility may communicate via one or more of a radio communication, a RFID, a SMS message, Bluetooth, a Wi-Fi network, a near field communication, and some other communication method. The application may be the software for guiding the practitioner host to use the medical device in the medical procedure. The application may also be a software wrapper for delivering the step-by-step workflow to a different application in the procedure instruction system, which application will load the step-by-step workflow and guide the practitioner host to use the medical device in the medical procedure.

In some embodiments, a unique device ID may be associated with the medical device. In some embodiments, the unique device ID may be stored on the medical device. The medical device may be adapted to transmit the unique device ID to the procedure instruction system. The unique device ID may be used to track the medical device for purposes. For example, the unique device ID may be reported to the FDA, used for recall and other safety purposes, or for billing purposes.

In embodiments, the procedure instruction system may check the application and the step-by-step workflow. In some embodiments, checking the application and the step-by-step workflow may include checking for data corruption, for example by checking the checksum value. Checking the application and the step-by-step workflow may also include connecting to a server to confirm that there are no updates to the application or to the step-by-step workflow. The server may be a storage server provided by the manufacturer of the medical device. In some embodiments, the storage server may be an application server with an application executing to provide information regarding the current status of the medical device and the current statuses and versions of the application and the step-by-step workflow. In some embodiments, the storage server may be a file server that provides the current versions of the application and the step-by-step workflow and, in which case, the procedure instruction system may compare the one or more of the application and the step-by-step workflow with an application and/or an step-by-step workflow on the server.

Similarly, the procedure instruction system may check the medical device. Checking the device may include running a diagnostic check on the device to confirm that it is in working order. Checking the device may also include connecting to a storage server, such as a storage server provided by the manufacturer of the medical device, to confirm that the medical device has not been recalled.

The methods and systems of procedure instruction disclosed herein may include a mask for a practitioner that may be adapted to facilitate voice based control and interaction with the procedure instruction system, with the specialist, or with any other aspect within or associated with the procedure environment. Such a mask may include a microphone and optionally some form of audio processing such as noise cancellation, voice recognition, and the like. In embodiments, the microphone may be a disposable microphone. Optionally the mask may be a conventional mask with a shield that may the worn on the head of a practitioner. In embodiments, the mask may be a disposable mask. The audio detection capabilities, such as a microphone, may be integrated with the attachable shield. Shields known in the industry such as clear Lucite shields to be placed in front of a practitioners face may be adapted to include the audio and for speech recognition capabilities described herein. Such an adapted shield or mask may use wireless or wired communication to transmit captured audio or commands detected from the captured audio to the procedure instruction system and/or any other component associated with the procedure environment. An example practitioner host may wear a mask and shield that may be adapted with a microphone and a wireless transmitter that may capture the practitioner host's speech and be provided wirelessly to the procedure instruction system where it may be analyzed for commands associated with the system.

The methods and systems of procedure instruction as described herein may include one or more servers that may control devices such as medical devices in a procedure environment such as an operating room and also may be connected through our network to a cloud-based environment. The server may communicate to the medical devices or other devices and computer equipment associated with a procedure in a procedure environment directly, via a local wireless network, through the cloud based communication, and any other electronic communication means. In an example a server, such as a server in a procedure instruction system, may communicate through a cloud environment to other servers or to other procedure instruction systems to provide guidance and/or instructions associated with a medical device and/or procedure to a practitioner host. Such a cloud connected server may provide benefits to a practitioner host who is using the procedure instruction system by allowing that practitioner host to benefit from information available through a cloud-based network.

Methods and systems of procedure instruction as described herein may also include or facilitate patient or practitioner host privacy through the use of video and/or audio obfuscation, such as facial obfuscation of a patient. The facial obfuscation may be enabled in various aspects of the procedure instruction system such as the video input portion, the video processing portion, the communication portion, and the like. In an example a practitioner host may be performing a procedure on a patient in an operating room and a specialist may be scheduled to interact through the audio and video capabilities described herein with the practitioner host during the procedure. To provide the optimal support for the practitioner host, the specialist may receive live video from the operating room including the use of the medical device, the procedure, the practitioner host, and the patient. Images that include the patient's face, for example, may include automatic obfuscation of the patient's face to prevent any possible recognition of the patient that may be detectable from patient's face. Obfuscation may also apply to other individuals in the procedure environment, such as medical assistance and the like. Obfuscation may be desirable for compliance with laws, such as the Health Insurance Portability and Accountability Act (“HIPAA”).

In methods and systems of a procedure instruction system, the procedure instruction system may be enabled, as previously described, to guide a practitioner host to use a medical device in a procedure environment, where the procedure instruction system may be comprised of a computing device connected to a plurality of viewing devices, which screens are enabled to present different views of the steps of a step-by-step workflow. Connecting the computing device to a plurality of viewing devices may be desirable so that each host practitioner of a plurality of host practitioners may view only the steps relevant to the particular host practitioner. For example, a surgeon may use one viewing device to display the current step in the procedure he is performing, while a circulating nurse uses a second viewing device to display the upcoming steps in the same procedure so that she knows which items to prepare for the surgeon. A viewing device may be a monitor, a screen (e.g. on a tablet or some other computing device), a hologram, a wearable display (e.g. Google Glass or some other wearable display), or some other viewing device.

In embodiments, presenting a view of the steps of a step-by-step workflow may include presenting a list of items (e.g. tools, materials, or other resources) required for such steps. In some embodiments, the steps of the step-by-step workflow may be presented as a cascade or Gantt chart on one or more of the viewing devices, to provide a global view of the steps and/or the list of item required for the steps.

In embodiments, methods and systems of a first procedure instruction system may comprise notifying one or more users of a second procedure instruction system that a host practitioner using the first procedure instruction system has almost completed the steps in an in-progress step-by-step workflow, and beginning a subsequent step-by-step workflow or step in the in-progress step-by-step workflow by the user(s) of the second procedure instruction system. For example, when a surgeon using a first procedure instruction system reaches the final step in surgical procedure, her procedure instruction system may notify a nurse using a second procedure instruction system that the surgical procedure is wrapping up and that the nurse should start gathering what is needed for the second surgical procedure. In the same example, the first procedure instruction system may also notify a support specialist to prepare to provide support for the surgeon performing the second surgical procedure. In embodiments, notifying the user(s) of the second procedure instruction system may include notifying the user(s) when the host practitioner using the first procedure instruction system has reached the final step in the in-progress step-by-step workflow. In embodiments, notifying the user(s) of the second procedure instruction system may include notifying the user(s) when the host practitioner using the first procedure instruction system has reached the second to last step in the in-progress step-by-step workflow. The notification may be comprised of several notices providing progress updates to the user(s) as the host practitioner gets closer to completing the in-progress step-by-step workflow. In a manufacturing example, when an auto worker using the first procedure instruction system reaches the second to last step in a procedure for assembling a car engine, his procedure instruction system may notify a second auto worker at the next station on the assembly line to prepare the station to receive the assembled engine.

Methods and systems for scheduling a plurality of resources may comprise logging times for steps taken in a step-by-step workflow associated with a procedure and a resource, projecting the completion time for the workflow, generating a schedule for the resource based on the projected completion time for the workflow. In some embodiments, an initial schedule may be created before the workflow begins and generating the schedule based on the projected completion time comprises generating an updated schedule based on the projected completion time and based on the initial schedule. The resource may be a room, a tool, a person, or some other resource. In a medical example, the resource may be a room (e.g. an operating room, an office, an emergency room, a cath room, or some other room), a tool (e.g. an MRI scanner, a CT scanner, an ultrasound machine, an EKG machine, or some other tool), a person (e.g. a physician, a surgeon, a specialist, a nurse, a nurse practitioner, a support specialist, or some other person), or some other resource. In a non-medical example, a tool may be a vehicle (e.g. a car, a private jet, a limousine, or some other vehicle), heavy machinery (e.g. a fork lift, a cement mixer, a road grader, a snow plow, a snow groomer, a drill press, a saw, or some other machinery), or some other tool.

It may be desirable to use a procedure instruction system to assist in scheduling resources, since the procedure instruction system may be tracking time and be able to project completion times. In embodiments where a plurality of procedure instruction systems may be connected, sharing the projected completion times may facilitate coordination and adjusting schedules based on changes to projected completion times.

Connecting a procedure instruction system to one or more other productivity systems may further enable the procedure instruction system to project and update schedules. For example, connecting the procedure instruction system to a customer resource management system may enable the procedure instruction system to identify when a patient has canceled an appointment or an emergency procedure has been added to the schedule, and reschedule resources, such as an operating room and medical devices, accordingly. Enabling the procedure instruction system to schedule resources and provide information to a support specialist may also assist the specialist in scheduling his appoints efficiently (e.g. grouping at around the same time a series of procedures he must be available to support).

In embodiments, methods and systems of a network of procedure instruction systems may be enabled to guide a plurality of practitioner hosts, where the network may be comprised of a plurality of procedure instruction systems, where each procedure instruction system may be comprised of a computing device, wherein the computing device may be comprised of a system for logging time stamp data about steps undertaken during a procedure, and a communication system that may be enabled to connect the procedure instruction system to one or more additional procedure instruction systems.

In embodiments, a procedure instruction system may be updated in response to a signal from a medical device, wherein the medical device attempts a handshake with the procedure instruction system, upon a successful handshake, the device may transmit an instruction to the procedure instruction system, and upon receiving the application and/or a procedure workflow, the procedure instruction system may initiate an application. The instruction transmitted to the procedure instruction system may be an application and/or a procedure workflow. The device may transmit other information, such as, for example, a device identification, a workflow identification, a procedure identification, or other information, in addition to the instruction. The device may initiate the update to the procedure instruction in response to a wake up event, such as scanning the device with a bar code scanner, turning the device on, moving the device, or some other event.

In embodiments, the application initiated by the procedure instruction system may be the application transmitted by the device. In embodiments, the procedure instruction system may check for updates to the instruction in response to receiving the instruction. The procedure instruction system may connect to a server maintained by the device manufacturer to check, for example, that the device has not been recalled, that there are no patches or other updates available for the application, and that there are no updates or revisions to the workflow.

As previously noted, the medical device may include a communication facility. The communication facility may communicate via one or more of radio communication, RFID, SMS message, Bluetooth, Wi-Fi network, near field communication, and some other communication method.

In some embodiments, methods and systems of a secure procedure instruction system may include providing a secure procedure instruction system, tracking one or more host practitioners in proximity with the secure procedure instruction system, and controlling access to the secure procedure instruction system based on the permissions granted to such host practitioners. Tracking the host practitioners may include identifying the host practitioners based upon one or more of a login, a security check at a door, a scan of identification card/badge or some other identification. Controlling access to the secure instruction system may include permitting access to the secure procedure instruction system by an identified host practitioner with sufficient permission and prohibiting access to the secure procedure instruction system by a host practitioner who was not identified and/or who did not have sufficient permission.

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with an analytic system that may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. By way of example, a practitioner may utilize an instruction system wherein a tablet device may be used to log time stamp data and other data associated with the procedure of inserting a stent in a patient. The device may log data associated with the procedure, and the analytic system may analyze the data taken during the medical procedure. By way of example, such analysis may provide information regarding the practitioner's proficiency in placing the stent, and the like.

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with methods and systems of procedure instruction that may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. By way of example, a practitioner may utilize an instruction system wherein a tablet device may be used to log time stamp data and/or other data associated with a procedure, and the feedback may provide information to a device manufacturer for device enhancement based on the data provided (e.g. requesting a left handed version of the device).

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with a procedure instruction system to send an automated message to a medical device specialist indicating that a medical procedure has been initiated and may provide contextual information about the procedure. By way of example, a practitioner may utilize an instruction system wherein a tablet device may be used to log time stamp data and/or other data associated with a procedure, and an automated message may be sent to a medical device specialist indicating that a procedure has been started by a particular practitioner at a particular location and how long the procedure will be expected to take. Accordingly the specialist may know to provide assistance for the procedure, when medical equipment will be available, and the like.

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with methods and systems of procedure instruction that may include the ability to operate the procedure instruction system with voice commands provided by a practitioner, a user and the like. By way of example, a practitioner may utilize an instruction system wherein a tablet device may be used to log time stamp data and/or other data associated with a procedure, and the practitioner may command the system with her voice such that she may tell the system to display the next step or to go back a step. This may provide the practitioner with the ability to focus more attention on the procedure and the patient rather than focusing on using the system.

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with methods and systems providing one or more servers that may control devices such as medical devices in a procedure environment. The procedure instruction system may be connected to one or more of the servers and may interact with one or more devices via the one or more servers. For example, the procedure instruction system may be connected to a server on a cart in an operating room, which server may be connected to a monitor and a foot pedal. In this same example, the server may send video output to the monitor based on commands it receives from the procedure instruction system and the server may send inputs received via the foot pedal to the procedure instruction system.

Methods and systems may guide a practitioner to use a medical device in a procedure environment where the procedure instruction system may be comprised of a tablet device, a system for logging time stamp data about the steps undertaken using a medical device and a communication system. Such methods and systems may be associated with methods and systems that may facilitate privacy through the use of video and/or audio obfuscation in various aspects of the procedure instruction system. By way of example, as a practitioner uses the procedure instruction system in a procedure environment to monitor technique and the timing of steps as completed by the practitioner, the practitioner may communicate with a specialist during the procedure who receives live video from the operating room, and the face or other identifying information of the patient may be blurred or otherwise blocked out to prevent the specialist from viewing such identifying information of the patient as the specialist assists the practitioner in using a particular medical device.

Methods and systems may guide a practitioner to use a medical device in a procedure environment where the procedure instruction system may be comprised of a tablet device, a system for logging time stamp data about the steps undertaken using a medical device and a communication system. Such methods and systems may be associated with methods and systems of procedure instruction that may guide a practitioner to use a medical device in an environment where the instruction system may be comprised of a computing device connected to a plurality of viewing devices which may present different views of one or more workflows. By way of example, a surgeon receiving guidance on the use of a medical device may use one viewing device to display the current step in the procedure he is performing, while a circulating nurse may use a second viewing device to display the upcoming steps in the same procedure so that she knows which items to prepare for the surgeon. In embodiments, a time stamp may be provided such that the nurse is aware whether or not the practitioner is behind an expected schedule.

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with methods and systems of a first procedure instruction system that may include notifying one or more users of a second procedure instruction system that a host practitioner using the first procedure instruction system has almost completed the steps in a workflow and beginning a subsequent workflow by the user(s) of the second procedure instruction system. By way of example, a practitioner may use said first procedure instruction system for guidance when using a medical device and the system may gather data related to the time the practitioner has logged on each step, and it may notify one or more users of a second system that the practitioner has completed a particular step in the workflow such that those associated with the second system may provide support or preparation for next steps in one or more workflows.

Methods and systems may guide a practitioner host to use a medical device in a procedure environment where the procedure instruction system may be comprised of a tablet device, a system for logging time stamp data about the steps undertaken using a medical device and a communication system. Such methods and systems may be associated with methods and systems for scheduling a plurality of resources that may comprise logging times for steps taken in a step-by-step workflow associated with a procedure and a resource, projecting the completion time for the workflow, and generating a schedule for the resource based on the projected completion time for the workflow. By way of example, a practitioner may utilize an instruction system wherein a tablet device may be used to log time stamp data and/or other data associated with a procedure, such as performing an EKG. As the practitioner completes each step, the completion time may be logged and a projected time for the EKG machine to be available may be computed such that schedule may be generated based on said completion time.

Methods and systems may guide a practitioner to use a medical device in a procedure environment where the procedure instruction system may be comprised of a tablet device, a system for logging time stamp data about the steps undertaken using a medical device and a communication system. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may connect the procedure instruction system to one or more additional procedure instruction systems. By way of example, a practitioner may utilize an instruction system wherein a tablet device may be used to log time stamp data and/or other data associated with a procedure, and such use may be associated with a plurality of other such methods and systems. In such embodiments, a practitioner may be aware of procedures in other environments for timing, scheduling, instruction and the like.

An analytic system may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. Such methods and systems may be associated with methods and systems of procedure instruction that may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. By way of example, a medical student's instructor may utilize the analytic system such as to analyze the performance of a medical student for a particular medical procedure and the feedback system may provide the feedback on the medical student's performance (e.g., feedback may include improving the timings associated with the steps of the medical procedure). By way of example, a medical device manufacturer may utilize the analytic system to examine the performance of the medical device during clinical trials and utilize the feedback system to improve the performance of the medical device for the medical procedure. Analysis and feedback on the time stamped information may improve the performance of the procedure instruction system.

An analytic system that may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. Such methods and systems may be associated with the methods and systems of procedure instruction may include a mask that may be adapted to facilitate voice based control and interaction with the system, specialist or an aspect within the environment. By way of example, the analytic system may analyze the time stamped information for a particular practitioner and may determine how much time the practitioner may spend on operating the system for communication purposes. In other words, the analytics may determine that user interaction (i.e., manual input) time with the system may create delays in performing the medical procedure. Accordingly, in such embodiments, this association may facilitate the performance of procedure instruction system by providing a mask to the practitioner such that the practitioner may use the mask to facilitate voice based control and interaction.

An analytic system may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. Such methods and systems may be associated with methods and systems of procedure instruction that may guide a practitioner to use a medical device in an environment where the instruction system may be comprised of a computing device connected to a plurality of viewing devices which may present different views of one or more workflows. By way of example, a practitioner may use the analytic system for analyzing the time stamped information about the steps taken during the medical procedure. The practitioner may utilize the analyzed time stamped information to enable viewing of the different steps on the plurality of viewing devices for a plurality of users. By way of example, a surgeon may use one viewing device to display the current step in the procedure he is performing, while a circulating nurse uses a second viewing device to display the upcoming steps in the same procedure so that she knows which items to prepare for the surgeon. This may improve the resource utilization of the procedure instruction system.

Methods and systems of a first procedure instruction system may include notifying one or more users of a second procedure instruction system that a host practitioner using the first procedure instruction system has almost completed the steps in a workflow and beginning a subsequent workflow by the user(s) of the second procedure instruction system. Such methods and systems may be associated with an analytic system that may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. By way of example, the procedure instruction system may be used by a medical practitioner in an operation room environment, wherein as the medical practitioner is about to complete a penultimate step in a first medical procedure, an instruction about subsequent steps is sent to one or more other medical practitioners and a time stamp logging data is sent to an operation supervisor. By the way of the same example, the one or more other medical practitioners may use the instruction to perform the subsequent steps and the supervisor may use the time stamp logging data to review medical practitioner's performance or to improve at least one of a medical device, a medical procedure, a practitioner host and a medical practice involving multiple medical practitioners.

An analytic system may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. Such methods and systems may be associated with methods and systems for scheduling a plurality of resources that may comprise logging times for steps taken in a step-by-step workflow associated with a procedure and a resource, projecting the completion time for the workflow, and generating a schedule for the resource based on the projected completion time for the workflow. By way of example, the practitioner may use the analytic system to determine the time stamped information of the steps in the workflow and associate the information with one or more medical devices. Accordingly, the procedure instruction system may generate a schedule for the medical device in accordance with the analyzed time stamped information. This schedule may allow the practitioner to determine whether a particular device may be available for a particular duration. This association may optimize the resource utilization within the procedure instruction system.

An analytic system may analyze time stamped information about steps taken during a medical procedure using a medical device on a patient and associating the time stamped information with the steps taken in a workflow for the medical procedure with the data associated with at least one of outcome of the procedure, the duration of steps undertaken, the practitioner host, the medical practice, and the medical device. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, the analytical data may be used to determine procedure execution time for a particular practitioner and determined execution time may be communicated to the plurality of procedure instruction systems so that the plurality of practitioners may schedule themselves in accordance with the determined execution time.

Methods and systems of procedure instruction may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. Such methods and systems may be associated with a procedure instruction system that may send an automated message to a medical device specialist indicating that a medical procedure has been initiated and may provide contextual information about the procedure. By way of example, the contextual information may include feedback information associated with the practitioner or the medical device. For example, an automated message may include insight (e.g., as provided by the feedback system) into the practitioners' and surgeons' experience that the specialist may utilize to determine how to provide support. This may assist the specialist to customize his guidance depending on the experience level of the practitioner.

Methods and systems of procedure instruction may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. Such methods and systems may be associated with the methods and systems of procedure instruction that may include a mask that may be adapted to facilitate voice based control and interaction with the system, specialist or an aspect within the environment. By way of example, the feedback system may log and the time stamp data about steps undertaken during a medical procedure using a medical device on the patient. Based on the comparison, the feedback system may provide a feedback to the practitioner such as to reduce the time that may be required to interact with the instruction system. Accordingly, the practitioner may use the mask that may facilitate the voice based control and interaction with the system. For example, the instruction system may log time stamp information based on one or more voice commands received through the mask and reduce the interaction time of the practitioner with the procedure instruction system.

Methods and systems of procedure instruction may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. Such methods and systems may be associated with methods and systems that may facilitate privacy through the use of video and/or audio obfuscation in various aspects of the procedure instruction system. By way of example, the feedback system may provide a feedback to the practitioner such as to maintain the privacy of the patient during the duration associated with the medical procedure. The practitioner may facilitate the privacy of the patient through the use of video and/or audio obfuscation while interacting with the specialist through a video and/or audio session during the medical procedure.

Methods and systems of procedure instruction may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. Such methods and systems may be associated with methods and systems of procedure instruction that may guide a practitioner to use a medical device in an environment where the instruction system may be comprised of a computing device connected to a plurality of viewing devices which may present different views of one or more workflows. By way of example, a procedure instruction system may be used in a medical environment, wherein a surgeon receiving guidance on the use of a medical device may use a first viewing device to view a stored video of the on-going step in a medical procedure. Further, a circulating nurse may be receiving instruction of a subsequent step in the medical procedure displayed on a second viewing device. The feedback system may provide the feedback to the surgeon to change or select a new step of the medical procedure and accordingly, the procedure instruction system may update the viewing screens of the surgeon and the nurse in accordance with the feedback.

Methods and systems of procedure instruction may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. Such methods and systems may be associated with methods and systems for scheduling a plurality of resources that may comprise logging times for steps taken in a step-by-step workflow associated with a procedure and a resource, projecting the completion time for the workflow, and generating a schedule for the resource based on the projected completion time for the workflow. By way of example, the feedback system may provide an estimate of how much time a particular practitioner may require to complete one or more steps of the medical procedure. Accordingly, this feedback may be communicated to a scheduler so that plurality of resources may be re-scheduled according to the completion timing associated with the particular practitioner.

Methods and systems of procedure instruction may include a feedback system for improving at least one of a medical device, a medical procedure, a practitioner host, and a medical practice and may include logging time stamped information about steps taken during at least one medical procedure by a practitioner host using a medical device on a patient and may compare the time stamped information with procedures described herein, where feedback may be provided. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, a procedure information system may be used by the medical practitioner in an operation room to communicate with network of a plurality of procedure information systems. The medical practitioner may provide feedback about a patient's condition or report a new development. The network of the plurality of procedure information systems may connect the medical practitioner to a suitable procedure information system based on feedback received from the medical practitioner about the patient's condition.

A procedure instruction system may send an automated message to a medical device specialist indicating that a medical procedure has been initiated and may provide contextual information about the procedure. Such methods and systems may be associated with methods and systems of procedure instruction that may include a mask that may be adapted to facilitate voice based control and interaction with the system, specialist or an aspect within the environment. By way of example, a practitioner host may use a mask to facilitate voice based control and interaction with the specialist and the procedure instruction system may send an automated message to the specialist indicating information that may be required by the practitioner during the medical procedure. This may enable the specialist to receive information substantial free of errors (that may come during audio communication due to loss of audio signals).

A procedure instruction system may send an automated message to a medical device specialist indicating that a medical procedure has been initiated and may provide contextual information about the procedure. Such methods and systems may be associated with methods and systems that may facilitate privacy through the use of video and/or audio obfuscation in various aspects of the procedure instruction system. By way of example, a practitioner may utilize the procedure instruction system in a procedure environment wherein a live streamed video of the procedure environment may be sent to the medical device specialist indicating that a medical procedure has been initiated and may provide contextual information about the procedure while keeping the face or other identifying information of the patient blurred or otherwise blocked out to prevent the specialist from viewing such identifying information of the patient as the specialist assists the practitioner in using the particular medical device.

A procedure instruction system may send an automated message to a medical device specialist indicating that a medical procedure has been initiated and may provide contextual information about the procedure. Such methods and systems may be associated with methods and systems of a first procedure instruction system that may include notifying one or more users of a second procedure instruction system that a host practitioner using the first procedure instruction system has almost completed the steps in a workflow and beginning a subsequent workflow by the user(s) of the second procedure instruction system. By way of example, the host practitioner may receive guidance from a first specialist using the first procedure instruction system and a second specialist using the second procedure instruction system. The second specialist of the second procedure instruction system may be notified through an automated message. That is to say, a host practitioner of the first procedure instruction system may indicate that he has almost completed the steps in a particular workflow and may begin the subsequent workflow. Accordingly, a message to the second specialist associated with the subsequent work low may be sent. The message may include information such as the outcome of the particular workflow so that the second specialist may consider this information while guiding the host practitioner for the subsequent workflow. This may decrease the response time of the second specialist and increase the collaboration among the plurality of procedure instruction systems.

A procedure instruction system may send an automated message to a medical device specialist indicating that a medical procedure has been initiated and may provide contextual information about the procedure. Such methods and systems may be associated with methods and systems for scheduling a plurality of resources that may comprise logging times for steps taken in a step-by-step workflow associated with a procedure and a resource, projecting the completion time for the workflow, and generating a schedule for the resource based on the projected completion time for the workflow. By way of example, a procedure information system may be used by a medical practitioner in an operation room environment for scheduling a plurality of medical procedure steps. By the way of the same example, the procedure information system may analyze a logging time data for each step in a medical procedure and project a completion time for the medical procedure. By the way of the same example, the procedure information system may send an automated message to the medical device specialist indicating that medical procedure has been initiated and may be completed in a projected time based on logging in details of each step. This may assist the medical device specialist to manage his assignments according to the schedule that may be communicated as a notification through the procedure instruction system.

Methods and systems of procedure instruction may include the ability to operate the procedure instruction system with voice commands provided by a practitioner, a user and the like. Such methods and systems may be associated with the methods and systems of procedure instruction that may include a mask that may be adapted to facilitate voice based control and interaction with the system, specialist or an aspect within the environment. By way of example, the host practitioner may use the mask to operate the procedure instruction system with the voice commands to other practitioners or users (e.g., nurses, medical staff, specialist and the like). This may enable the host practitioner to perform the medical procedure without worrying on the operational (i.e., interaction) aspects of the procedure instruction system.

Methods and systems of procedure instruction may include the ability to operate the procedure instruction system with voice commands provided by a practitioner, a user and the like. Such methods and systems may be associated with methods and systems of procedure instruction that may guide a practitioner to use a medical device in an environment where the instruction system may be comprised of a computing device connected to a plurality of viewing devices which may present different views of one or more workflows. By way of example, the practitioner may provide voice commands to present different view of one or more workflows on the plurality of viewing devices. This may provide comfort to the practitioner in providing input to the procedure instruction system such as to update different views of one or more workflows on the plurality of viewing devices.

Methods and systems of a first procedure instruction system may include notifying one or more users of a second procedure instruction system that a host practitioner using the first procedure instruction system has almost completed the steps in a workflow and beginning a subsequent workflow by the user(s) of the second procedure instruction system. Such methods and systems may be associated with methods and systems of procedure instruction that may include the ability to operate the procedure instruction system with voice commands provided by a practitioner, a user and the like. By way of example, a procedure information system may be used in an environment wherein, a first medical practitioner receives a first set of instructions to perfume a medical procedure on a patient. By the way of same example, as the medical practitioner completes a penultimate step, a second set of instruction is selected and sent to one or more other medical practitioner about subsequent steps based on voice and verbal content recognition of the first medical practitioner.

Methods and systems of procedure instruction may include the ability to operate the procedure instruction system with voice commands provided by the practitioner, a user and the like. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, the practitioner may communicate using the voice commands with the other practitioners that may be accessible through the network of procedure instruction systems. Such embodiments may increase the collaboration among the practitioners that may work on the similar or different workflows. The voice based operations may further reduce the input time for sharing inputs among the practitioners.

The methods and systems of procedure instruction may include a mask that may be adapted to facilitate voice based control and interaction with the system, specialist or an aspect within the environment. Such methods and systems may be associated with methods and systems that may facilitate privacy through the use of video and/or audio obfuscation in various aspects of the procedure instruction system. By way of example, a procedure information system may be used in a medical environment wherein the practitioner may interact with at least one of a medical device specialist and the practitioner may use the mask that may facilitate the voice based interaction with the specialist. Further, the practitioner may blur or block any identifying information associated with the patient while interacting with the specialist. This may provide the patient and practitioner assistance of the specialist without fearing on the leakage of private data associated with the patient.

The methods and systems of procedure instruction may include a mask that may be adapted to facilitate voice based control and interaction with the system, specialist or an aspect within the environment. Such methods and systems may be associated with methods and systems of procedure instruction that may guide a practitioner to use a medical device in an environment where the instruction system may be comprised of a computing device connected to a plurality of viewing devices which may present different views of one or more workflows. By way of example, a procedure instruction system may be used in a medical environment wherein different views of the one or more workflows are presented on a plurality of viewing devices. The practitioner may use the mask to facilitate the voice based control of the system. For example, the practitioner may issue one or more commands through the mask such as to update or remove the one or more workflows presented on the one or more viewing devices. This may increase the comfort of using the procedure instruction system.

The methods and systems of procedure instruction may include a mask that may be adapted to facilitate voice based control and interaction with the system, specialist or an aspect within the environment. Such methods and systems may be associated with methods and systems for scheduling a plurality of resources may comprise logging times for steps taken in a step-by-step workflow associated with a procedure and a resource, projecting the completion time for the workflow, and generating a schedule for the resource based on the projected completion time for the workflow. By way of example, a procedure information system may be used in a medical environment wherein a medical practitioner may interact with at least one of a medical device specialist, and any person from the medical environment using a mask. By the way of same example, a schedule of various resources in the medical environment may be altered based on voice based commands received from the medical practitioner. Usage of the mask for scheduling may decrease the interaction time of the users and thereby, may increase the efficiency of the procedure instruction system.

Methods and systems may facilitate privacy through the use of video and/or audio obfuscation in various aspects of the procedure instruction system. Such methods and systems may be associated with methods and systems of procedure instruction that may guide a practitioner to use a medical device in an environment where the instruction system may be comprised of a computing device connected to a plurality of viewing devices which may present different views of one or more workflows. By way on an example, the practitioner may use the medical device on the patient one or more workflows. The procedure instruction system may display the different views of one or more workflows on the different viewing devices (e.g., monitor). The procedure instruction system may facilitate privacy of the patient information through the use of video and/or audio obfuscation while different views of the medical procedure are provided on the different monitors. This may ensure the protection of identify information of the patient.

Methods and systems may facilitate privacy through the use of video and/or audio obfuscation in various aspects of the procedure instruction system. Such methods and systems may be associated with methods and systems of a first procedure instruction system may include notifying one or more users of a second procedure instruction system that a host practitioner using the first procedure instruction system has almost completed the steps in a workflow and beginning a subsequent workflow by the user(s) of the second procedure instruction system. By way of example, the procedure instruction system may be used in a multiple medical procedure environment by a medical practitioner in an operating room working on a first medical procedure. The medical practitioner may send an instruction to a support staff or any other medical practitioner working on a second medical procedure that the first medical procedure has almost completed while blocking or blurring any identifying information about the patient under the first medical procedure. By the way of same example, a medical practitioner operating on the patient may send an instruction to a nurse to begin preparation of an operation room for the operation when the task previously allocated to the nurse is almost complete while blocking an identity of the patient.

Methods and systems may facilitate privacy through the use of video and/or audio obfuscation in various aspects of the procedure instruction system. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, a procedure information system may be used by the medical practitioner in an operation room to communicate with network of a plurality of procedure information systems. The medical practitioner may need to communicate the status of the patient either to a specialist or a practitioner of other procedure instruction system. This association may facilitate privacy of the patient identity information through the use of video and/or audio obfuscation techniques.

Methods and systems of procedure instruction may guide a practitioner to use a medical device in an environment where the instruction system may be comprised of a computing device connected to a plurality of viewing devices which may present different views of one or more workflows. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, a procedure instruction system may be connected to network comprising a plurality of procedure instruction systems having a computing device. By the way of the same example, a procedure instruction system may be used in a medical environment, wherein a first surgeon receiving guidance on the use of a medical device may use a first viewing device to display an on-going step in a medical procedure he is performing. By the way of the same example, a second surgeon connected to the network at a different location may receive guidance on the use of the same medical device that may be used by the first surgeon. The second surgeon may receive the guidance on a second display device. By the way of the same example, the procedure instruction system and the network may be automated to provide instructions to a plurality of medical procedures and a plurality of medical practitioners at the same time irrespective of location of the medical practitioners.

Methods and systems of a first procedure instruction system may include notifying one or more users of a second procedure instruction system that a host practitioner using the first procedure instruction system has almost completed the steps in a workflow and beginning a subsequent workflow by the user(s) of the second procedure instruction system. Such methods and systems may be associated with methods and systems for scheduling a plurality of resources that may comprise logging times for steps taken in a step-by-step workflow associated with a procedure and a resource, projecting the completion time for the workflow, and generating a schedule for the resource based on the projected completion time for the workflow. By way of example, the procedure information system may generate a schedule for the one or more resources based on the projected completion time for the workflow. The host practitioner of the first procedure instruction system may notify to the one or more users of the second procedure instruction system that he has almost completed the steps in the workflow and may begin the subsequent workflow. This may allow the one or more users of the second procedure instruction system to check for the resources that may be available after the completion of the workflow resulting in optimized usage of the resources.

Methods and systems of a first procedure instruction system may include notifying one or more users of a second procedure instruction system that a host practitioner using the first procedure instruction system has almost completed the steps in a workflow and beginning a subsequent workflow by the user(s) of the second procedure instruction system. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, the one or more practitioners may operate in a multiple procedure instruction system environment. In a scenario, a second practitioner of a second procedure instruction system may perform a particular workflow after the completion of the workflow of a first practitioner of the first procedure instruction system. By way of the same example, the first practitioner may communicate to the second practitioner of the second procedure instruction system that he has almost completed the steps in his workflow. This prior notification of about to be completed workflow may assist the second practitioner to prepare in advance for the one or more steps of his workflow.

Methods and systems for scheduling a plurality of resources may comprise logging times for steps taken in a step-by-step workflow associated with a procedure and a resource, projecting the completion time for the workflow, and generating a schedule for the resource based on the projected completion time for the workflow. Such methods and systems may be associated with methods and systems of a network of procedure instruction systems that may guide a plurality of practitioners where the network may be comprised of a plurality of procedure instruction systems that may be comprised of a computing device that may be comprised of a system for logging time stamp data about steps undertaken during a procedure, and a communication system that may be enabled to connect the procedure instruction system to one or more additional procedure instruction systems. By way of example, a procedure instruction system may be used in a medical environment where a plurality of medical practitioners may be connected to a network that may be used to guide and schedule resources for the plurality of medical practitioners for performing a plurality of medical procedures. By the way of the same example, every medical practitioner may receive a set of resources (e.g., circulating nurses, medical devices) for projected completion time for each task. Various resources of various medical practitioners in the network may be managed to ensure a continuous workflow and an optimal utilization of all resources.

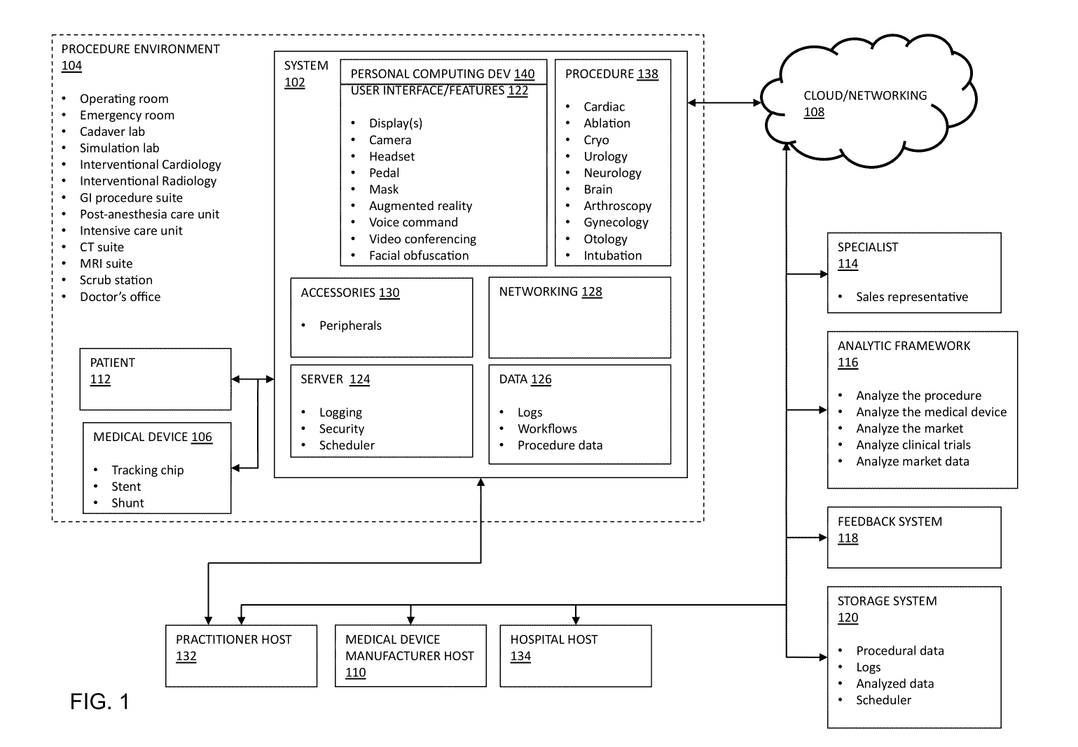

Methods and systems for assisting a practitioner host in the use of a medical device to perform a procedure on a patient are depicted in FIG. 1. The methods and systems depicted in FIG. 1 may include a procedure instruction system 102 that may be deployed at least in part in a procedure environment 104, such as an operating room (OR). The procedure instruction system 102 may interface to devices without or outside of the procedure environment 104, such as through a network that may facilitate connection through the cloud or other networking 108 to third party systems for purposes such as interfacing with a procedure specialist 114, an analytic framework 116, a feedback system 118, a data storage system 120, a hospital/procedure environment host 134, a medical device manufacturer host 110, a practitioner host 132, and the like. The procedure instruction system 102 may further interface with elements within the procedure environment 104, such as a patient 112, a medical device 106, a practitioner host 132, and the like.

The procedure instruction system 102 may be deployed in a wide variety of procedure environments, including without limitation, an operating room, an emergency room, a cadaver lab, a simulation lab, an interventional cardiology or radiology suite, a gastro-intestinal suite, a post-anesthesia care unit, an intensive care unit, a CT suite, an MRI suite, a scrub station, a doctor's office, a field office, an emergency medical technician vehicle, an ambulance, a nursing home, a maternity ward, an infirmary, a medical health center, and the like. The procedure instruction system 102 may be portable and/or transportable so as to be deployable in any environment in which a procedure is being performed.

The procedure instruction system 102 may include a user interface 122 with various features including a tablet, one or more displays, a camera, a headset, a pedal, a microphone enabled mask, augmented reality features, a voice command recognition and response facility, a video conference capability, patient facial obfuscation features, and the like. The procedure instruction system 102 may include and/or may interface with accessories 130, networking 128, a server 124 that may facilitate logging data, providing security, and maintaining practitioner and specialists schedule(s), and data 126 that may include procedure logs, workflows, and procedure data.

A wide range of medical devices 106 may be provided for use in or accessible by the procedure instruction system 102 in a procedure environment 104. Medical devices 106 may include, without limitation a catheter, a stent, a delivery device (e.g. a port or an infusion pump, and the like), a retrieval device, an implanted device (e.g. cochlear, replacement joint, breast, phakic intraocular lenses), vascular assist device, insulin pump, monitoring device (e.g. a glucose monitor), an imaging device (e.g. an ultrasound), a shunt, a prosthetic, a gastric band, an external feeding device, an in vitro diagnostic device, a pulse generator, an anchor system, dental devices (e.g. dentures, cap, crown), and the like.

Likewise a wide range of procedures 138 may be delivered to a practitioner by the procedure instruction system 102 including, without limitation, cardiac procedures (e.g. a stent, a balloon catheter, a valve replacement, a shunt, and the like), ablation procedures, cryo procedures, urology procedures (e.g. harness/mesh, lithotripsy), neurology procedures, brain related procedures, arthroscopy, joint replacement, gynecology, internal medicine, otology, organ replacement, dental, gene therapy, oncology, intubation, turbinoplasty, cosmetic surgery (e.g. liposuction, LASIK, and the like), and the like

The analytic framework 116 may facilitate tracking and analysis of activities related to one more procedures, medical devices, and the like. Tracking and analysis may facilitate improvement of a medical device and/or procedure. In an example, an analysis framework 116 may facilitate improvement of the medical device by helping to identify aspects of the medical procedures such as which steps take the longest, which features are most difficult to use, which features fail and or produce non-optimal results, what features do surgeons prefer or dislike in a medical device, what steps in the procedure are most often modified, skipped, and/or added by surgeons. The analytic framework 116 may alternatively facilitate improvements of a surgeon or practitioner by helping to determine how long a surgeon might take to perform a procedure relative to a normal for a portion or a step in the procedure, what training related to the procedure or use of the medical device could improve a surgeon's performance, and the like. Similarly, an analytic framework 116 many facilitate improvements of a procedure, such as by helping to determine what steps in the procedure take too long or are too complicated for a practitioner to follow without extensive training, what steps lead to poorer outcomes, what steps in the procedure are most often modified, skipped, and or added by practitioners, and the like. Data that is captured and/or made available to analytic framework 116 may include data on device characteristics, physicians, procedures, individual steps of a procedure, hospitals, practices, specialists provides support for the procedures, and the like. In general, an analytic framework 116 may be helpful in determining what is creating delays, what is creating adverse outcomes, what is creating excess costs, what opportunities are being missed, what features of the medical device are being used or not used, predicting outcomes based correlations of data that have been collected with real-time procedure data being collected, cost impact for efficiency improvements of a medical device, return on investment, and the like.

A feedback system 118 may enable capture of analytical data, practitioner comments and observations, device generated feedback data, and the like. The feedback system 118 further facilitates logging feedback or commentary from a surgeon or practitioner during use of the medical device. Likewise feedback on a procedure such as through surgeon or practitioner comments or remarks may be valuable in determining how a procedure may be upgraded to improve the quality of the procedure, quality of outcomes of procedure, compliance of the procedure with the medical device, and the like. A feedback system 118 may also provide insight into the rating of practitioners and surgeons that may facilitate determining the best in the worst practitioners based on procedure and a medical device on which the feedback is collected. In addition, feedback specifically on areas of improvement, on device characteristics, and the like may be captured and made available to a user or other individual or system for maintaining and/or improving medical device and/or the procedure instruction system 102.

A specialist interface 114 may include providing live video chat and/or conferencing with a specialist. The specialist interface 114 may include providing procedure-tracking information for a procedure being executed to provide context-specific information and/or images from a procedure environment 104 to a specialist and/or from a specialist through the specialist interface 114 to a practitioner, surgeon, or other user of a medical device 106.

Referring again to FIG. 1, a system in a procedure environment 104 may be associated with a medical device 106. In one embodiment, the system may be a computer. In another embodiment, the system may be a plurality of connected computers. In some embodiments, the plurality of computers may include a user interface 122 and a server 124 connected by a network 108. The network 108 may be, for example, the Internet, an intranet, a personal area network, a VPN, a local area network, a wide area network, a metropolitan area network, or some other network. In some embodiments, the user interface 122 is provided by a personal computing device 140. In some embodiments, the personal computing device 140 is a tablet device such as, but not limited to, an APPLE IPAD, a SAMSUNG GALAXY TAB, a BLACKBERRY PLAYBOOK, an ASUS EEE PAD TRANSFORMER, an ACER ICONIA TAB, an AMAZON KINDLE FIRE, an HP TOUCHPAD, a LENOVO IDEAPAD, or some other tablet device. The personal computing device 140 may run one or more operating systems, such as, but not limited to, Microsoft Windows, Android, Apple iOS, Blackberry OS, or some other operating system. In embodiments, the system may be developed in and/or developed to support Flash, HTML5, XML, ASP, Javascript, CSS, AJAX, DOM, and other coding technologies.

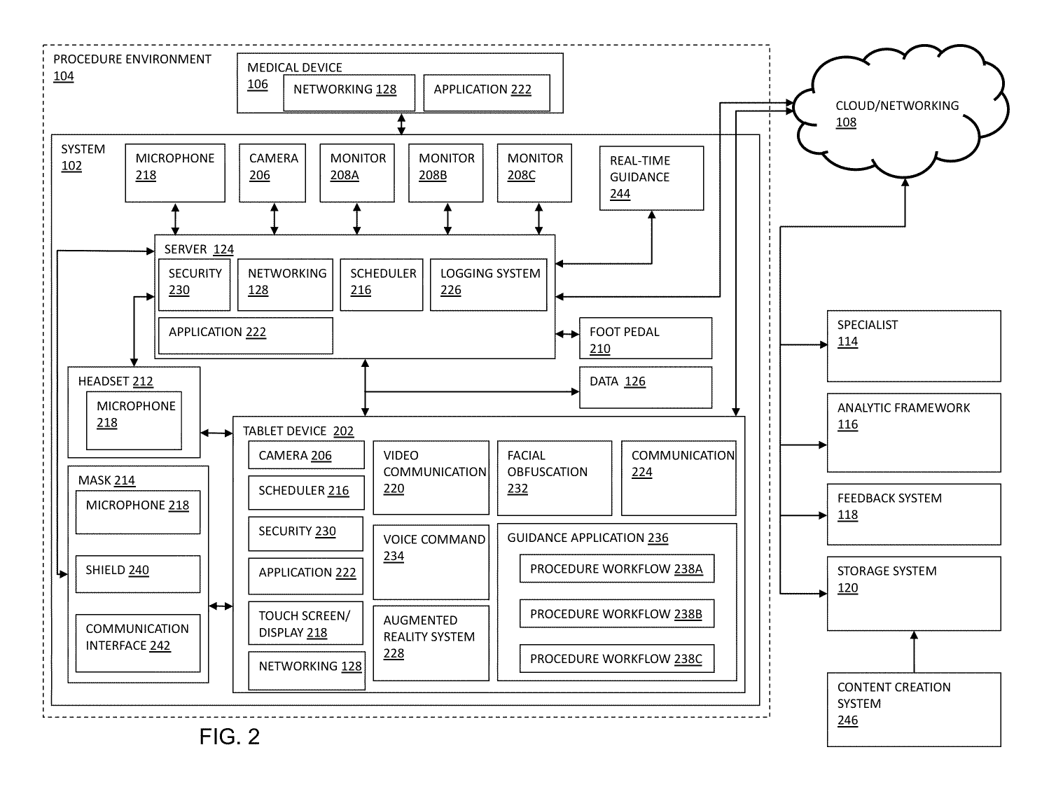

Referring now to FIG. 2, a tablet device 202 may be comprised of one or more capabilities or functions including networking 128, image/video acquisition 206 (e.g. via a camera), scheduling 216, security 230, applications 222, display, video communications 220, voice recognition for control/command 234, augmented reality 228, facial obfuscation 232, communication 224, procedure guidance 236, and the like. In one embodiment, the camera 206 is a video camera. In an embodiment, the display is a touchscreen 218. In one embodiment, the touchscreen 218 is adapted to accept input using a stylus. In another embodiment, the touchscreen 218 is adapted to accept input using a virtual keyboard. In other embodiments, the touchscreen 218 is adapted to accept input from a hand, such as, but not limited to, a press, a movement, gestures with multiple fingers, and other inputs.

The server 124 may be a computer for controlling one or more system components. In one embodiment, the server 124 may connect to cloud-based networking 108. In some embodiments, the server 124 may be enabled to connect to one or more computing devices, for example, but not limited to a medical device 106, a personal computer, a tablet, a feedback system 118, a storage system 120, or other computing devices. In some embodiments, the server 124 may also be able to connect to one or more accessories 130. In one embodiment, the server 124 may be comprised of one or more of networking 128, a scheduler 216, security 230, an application 222, a logging system 226, a guidance application 236, a procedure data, and a display. In one embodiment, the camera 206 is a video camera. The storage system 120 may be connected to a content creation system 246. The content creation system 246 may be a tool for generating content and may store such content in the storage system 120.

Networking 128 may enable a computer to connect to one or more other devices. In some embodiments, the computer is a server 124. In some other embodiments, the computer is a tablet device 202. In some embodiments, the other device may be another computer. In one embodiment, the other device may be a medical device 106. Networking 128 may enable the computer to connect to one or more such other devices using a network 108, such as, but not limited to the Internet, an intranet, a personal area network, a VPN, a local area network, a wide area network, a metropolitan area network, or some other network. Networking 128 may communicate with cloud-based networking 108. In one embodiment, networking 128 may communicate via cloud-based networking via a network, such as, but not limited to the Internet, an intranet, a personal area network, a VPN, a local area network, a wide area network, a metropolitan area network, or some other network.

Security 230 may enable protecting information stored on a computer. In one embodiment, the information is stored in volatile storage, for example, but not limited to DRAM, DDR, SDRAM, SRAM or other volatile storage. In another embodiment, the information is stored in non-volatile storage, for example, but not limited to ROM, Mask ROM, programmable read-only memory (PROM), erasable programmable read-only memory (EPROM), electrically erasable programmable read-only memory (EEPROM), non-volatile random-access memory (NVRAM), Flash memory, non-volatile random-access memory (nvSRAM), ferroelectric random-access memory (FeRAM), magnetoresistive random-access memory (MRAM), phase-change memory (PRAM), or other non-volatile storage. In some embodiments, security 230 enables securing information by comparing an input biometric against a stored biometric to verify an identity. For example, security 230 may compare an input thumb-, finger-, or hand-print; voice; retina scan; and/or DNA sample to a stored thumb-, finger-, or hand-print; voice; retina scan; and/or DNA sample. Security 230 may be adapted to enable a password protection. Security 230 may also be adapted to enable other software-based security measures, including, but not limited to encryption, virus protection/scanning/remediation, and a firewall.

In some embodiments, the scheduler 216 may be an application for scheduling one or more medical procedures. The scheduler 216 may schedule a medical procedure based on input from one or more of a practitioner host 132, a medical device manufacturer host 110, a specialist 114, a patient 112, a medical device 106 and some other input source. The scheduler 216 may also associate procedure data with the medical procedure with a medical device 106. This scheduler 216 may connect to a storage system 120 via a network 108 and download procedure data to the system before the medical procedure begins. In an example, the scheduler 216 may, at the beginning of a calendar day, download procedure data for each and every medical procedure that the practitioner host 132 has scheduled that day in an operating room. In some embodiments, the scheduler 216 downloads such procedure data to the tablet device 202. In other embodiments, the scheduler 216 downloads such procedure data to a server 124. In other embodiments, the scheduler 216 may connect with a specialist support routing system 702 to schedule a live video interaction between the practitioner host 132 and a specialist 114.

In some embodiments, the system may execute an application 222. In some embodiments, the application 222 is a guidance application 236 for providing a procedure workflow 238A-C to a practitioner host 132. The procedure workflow 238A-C may be associated with one or more of a medical device 106, a practitioner host 132, a medical procedure or some other source of procedure workflow 238A-C information. In one embodiment, the procedure workflow 238A-C includes steps for a practitioner host 132 to follow in order to perform the medical procedure. For example, the procedure workflow 238A-C steps may be the steps defined in a DFU or an IFU for utilizing a medical device 106. In some embodiments, the procedure workflow 238A-C may also include audio and video elements. The audio element of the procedure workflow 238A-C may be audio narrating the steps of the procedure workflow 238A-C. The video element of the procedure workflow 238A-C may be video displaying each action to be taken for each step of the procedure workflow 238A-C. The procedure workflow data may also include text. For example, the procedure workflow 238A-C may include text from an associated DFU, which text may be displayed by the system, based on an input from the practitioner host 132. In some embodiments, the procedure workflow 238A-C may include optional steps that may be, for example, modified, reordered, and/or deleted. In another embodiment, a procedure workflow 238A-C may be modified by permitting the practitioner host 132 to insert one or more additional steps.

The guidance application 236 may be enabled to provide a plurality of procedure workflows. In one embodiment, the guidance application 236 may be enabled to modify a procedure workflow 238A-C based on input from a practitioner host 132. For example, a practitioner host 132 may direct the guidance application 236 to insert one step in the procedure for marking an incision, direct the guidance application 236 to remove an optional step in the procedure workflow 238A-C, and direct the guidance application 236 to modify the order location of a third step in the procedure workflow 238A-C.

In some embodiments, the system may be adapted to incorporate one or more accessories 130. In embodiments, an accessory may be a foot pedal 210 attached to the server 124. The foot pedal 210 may be used to control the system, such as for providing an input to the guidance application 236, to the application 222, or to the logging system 226. For example, input from the foot pedal 210 may be used to advance the guidance application 236 to a next step in the procedure workflow 238A-C. As discussed below, accessories 130 may also be a headset 212 and a mask 214. The system may also be adapted to incorporate one or more audio/visual accessories. In some embodiments, the system may be adapted to incorporate one or more cameras in a procedure environment 104. As noted above, the tablet device 202 may have a camera 206. In some embodiments, there may be one or more cameras located in the procedure environment 104. For example, there may be one or more cameras in an operating room for capturing images and/or video of a medical procedure. The procedure environment 104 may also have one or more monitors. The monitors may be connected to the system to display visual information from the system. For example, an operating room may have several monitors connected to the system to display video captured by a camera 206 recording the medical procedure and that is attached to the system. In another example, one monitor 208A may be displaying video of the medical procedure from a camera 206 attached to the system and a second monitor 208B may display video from a video communication 220 with a specialist 114. In another example, a surgeon may use a first monitor 208A displaying video of the medical procedure, a circulating nurse may use a second monitor 208B displaying the list of tools that are needed for the upcoming steps in the procedure, and another nurse assisting the surgeon may use a third monitor 208C displaying text describing the nurse's workflow for the medical procedure.

In some embodiments, the system may be adapted to receive and respond to voice commands 234 via a voice command 234 capability. In some embodiments, the voice command 234 capability may execute on the table device. The voice commands 234 may be from a practitioner host 132 using the system using a medical device 106 during a medical procedure. In some embodiments, the voice command 234 capability receives input from a microphone or a plurality of microphones. A microphone 218 may be incorporated into the tablet device 202. One or more microphones 218 may be attached to the system. For example, an array of microphones 218 may be installed in the procedure environment 104 and connected to the server 124. In some embodiments, one or more microphones 218 may be attached to the system via an accessory. In some embodiments, a headset 212 is adapted to incorporate a microphone 218 and attached to the system. In some embodiments, such headset 212 is connected to the server 124 via one of a wired connection, a wireless connection, a Bluetooth connection, or some other type of connection. In some embodiments, such headset 212 is connected to the tablet device 202 via one of a wired connection, a wireless connection, a Bluetooth connection, or some other type of connection. In other embodiments, a mask 214 is adapted to incorporate a microphone 218 and attached to the system. In some embodiments, such mask 214 is connected to the server 124 via one of a wired connection, a wireless connection, a Bluetooth connection, or some other type of connection, such as through communication interface 242. In some embodiments, such mask 214 is connected to the tablet device 202 via one of a wired connection, a wireless connection, a Bluetooth connection, or some other type of connection, such as through communication interface 242. The mask 214 may include or be associated with an element, such as a shield 240 that may protect the wearer of the mask 214 and/or any portion of the mask from elements in the procedure environment 104.

In one embodiment, the system may be adapted by a facial obfuscation 232 that may enable a video communication 220 with real time obfuscation of one or more subjects in the video. The obfuscation may hide the identity of the subject such as, but not limited to by providing a bar over the subject's eyes, providing a bar over the subject's face, distorting the image of the subject's face, providing another image over the subject's face, or some other obfuscation. For example, facial obfuscation 232 may receive a video feed of a medical procedure from a camera 206 associated with the system, overlay a black strip on the face of the patient 112 in the video feed, and the modified video feed may be communicated to the specialist 114 providing support to the practitioner host 132. Providing facial obfuscation 232 may be desirable so that the practitioner host 132 may share images of the procedure with third parties in order to receive support, while maintaining compliance with certain privacy laws, such as HIPAA.

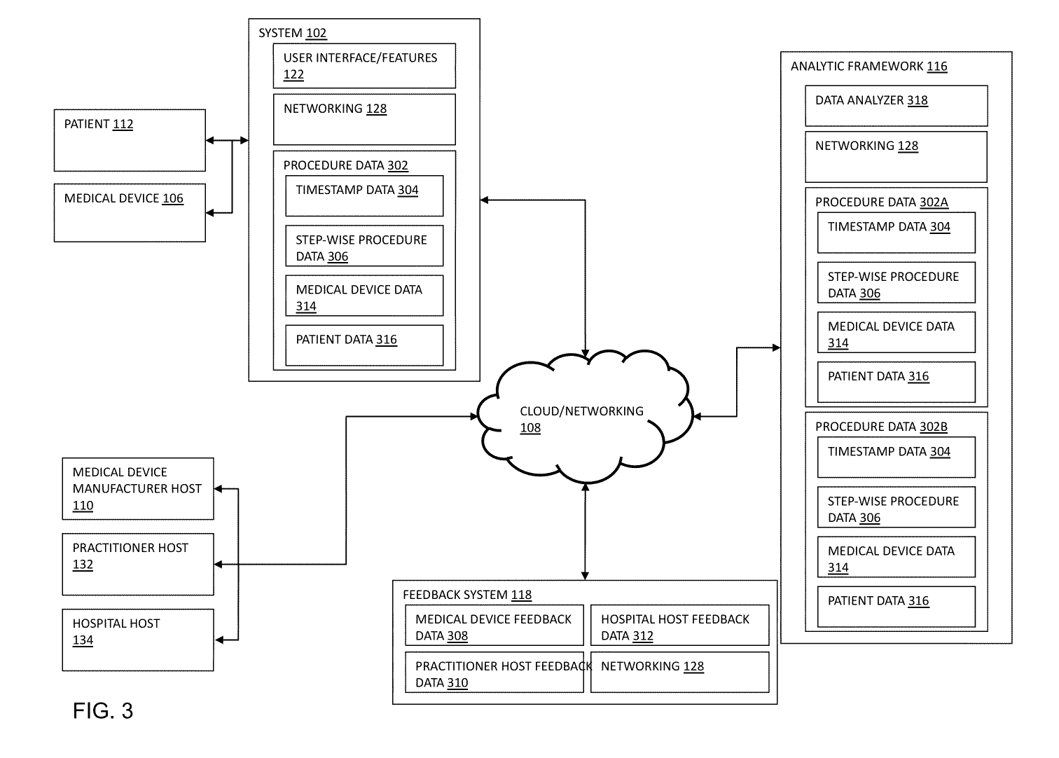

Referring now to FIG. 3, the data residing in the system may be procedure data 302 A-B. The procedure data 302 may include information such as, but not limited to timestamp data 304, step-wise procedure data 302, medical device data 314, patient data 316, feedback data (e.g. medical device feedback data 308, hospital feedback data 312, and practitioner host feedback data 310), and other data. The timestamp data 304 may include logged information regarding a medical procedure, such as, but not limited to a start timestamp for a medical procedure, a start timestamp for each step in a medical procedure, an end timestamp for each step in a medical procedure, an end timestamp for a medical procedure, and other logged information with a timestamp. The step-wise procedure data 306 may include information recorded regarding one or more steps in a medical procedure, such as, but not limited to modifications to a stored procedure workflow 238 A-C associated with a medical procedure, notes recorded by a host practitioner associated with one or more steps in a medical procedure, and other information regarding one or more steps in a medical procedure. The medical device data 314 may include information regarding a medical device 106 used in a medical procedure, such as, but not limited to one or more states of the medical device 106, one or more feedback data from the medical device 106, location information of the medical device 106 and other information regarding the medical device 106. The patient data 316 may include information associated with a patient 112 who is the subject of a medical procedure, such as, but not limited to one or more diseases associated with the patient 112, a medical history associated with the patient 112, a drug history associated with the patient 112, a surgical history associated with the patient 112, one or more states associated with the patient 112 during the medical procedure, post-procedure instructions associated with the medical procedure and other information associated with a patient 112 who is the subject of the medical procedure.

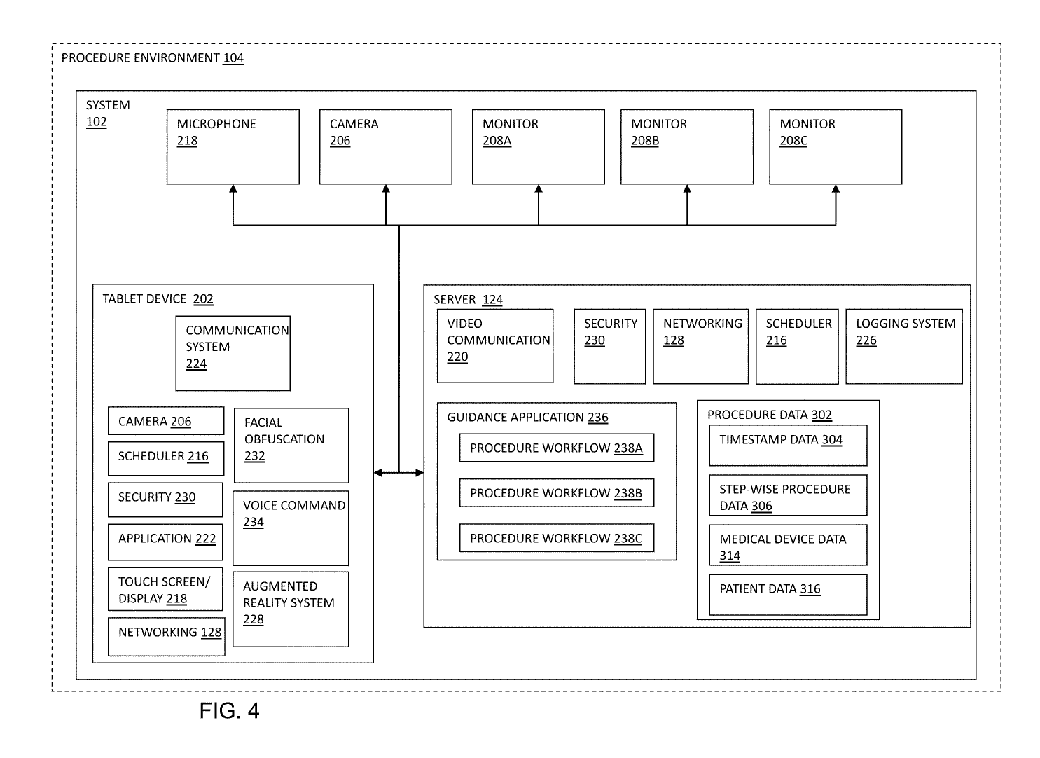

Referring now to FIG. 4, various aspects of the procedure instruction system 102 may be embodied in the tablet device 202 while these and other aspects may be embodied in the server 124 while being accessible to the tablet device 202. In the embodiment depicted in FIG. 4, functionality such as security 230, networking 128, scheduling 216, and the like is shown as being deployable in the tablet device 202, the server 124 or both. Similarly, functionality such as guidance applications 236 may be embodied in the server 124, yet in other embodiments, the guidance applications 236 may be embodied in the tablet device 202 or in other aspects of the procedure guidance system 102. Data, such as procedure data 302 may be stored in association with a data storage facility that is accessible by the server 124. As depicted in FIG. 4, such procedure data 302 may be accessible to the tablet device 302 via an interface with the server 124. Some aspects of the procedure instruction system 102 may be found to be commonly accessible by the server 124 and the tablet device 202, such as a microphone 218, a camera or video source 206, and one or more monitors 208A-C.

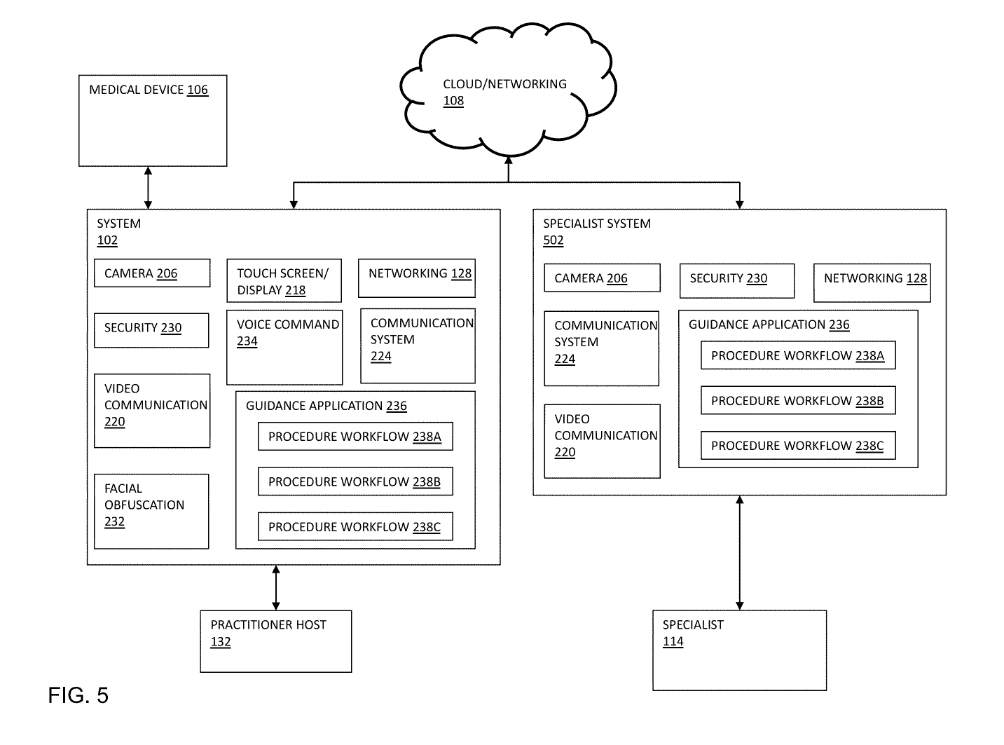

Referring now to FIG. 5, the system may enable a live video interaction between a practitioner host 132 performing a medical procedure with a medical device 106 and a specialist 114 for the medical device 106. In one embodiment, the system may enable the live video interaction by means of video communication 220. Video communication 220 may encode video input from a camera 206 and transport such video input to the specialist 114. In some embodiments, the video input may be transported by communicating via cloud-based networking 108. In embodiments, the specialist 114 may be connected via cloud/networking 108 by a specialist system 502.

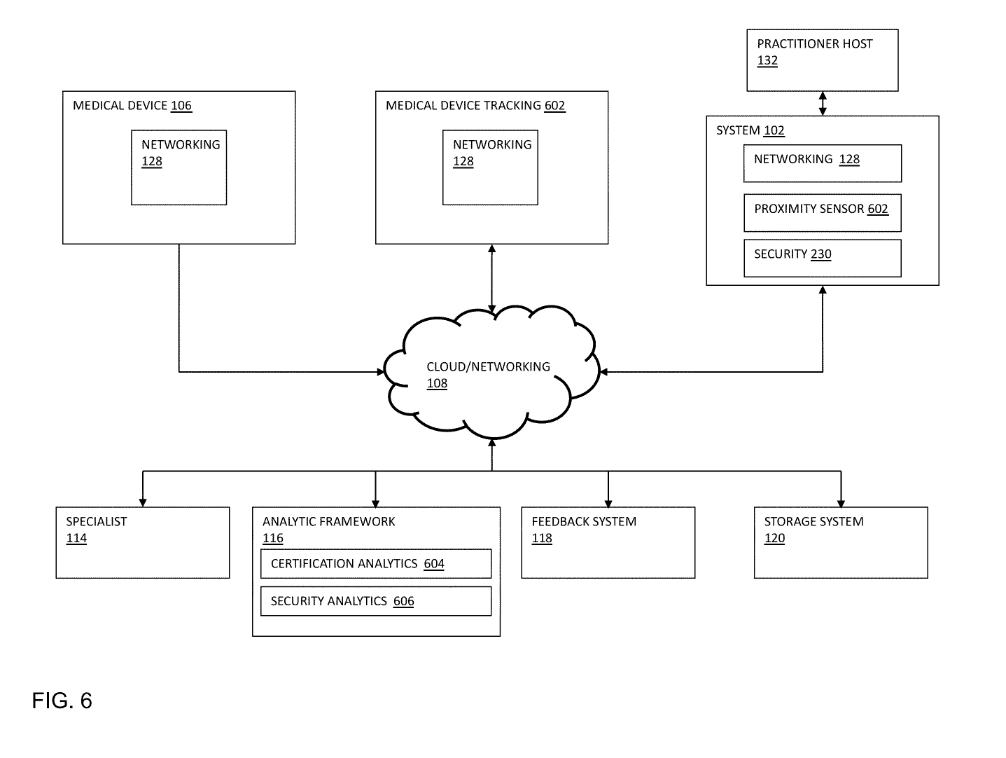

Referring now to FIG. 6, an embodiment is depicted that includes aspects of the methods and systems described herein such as an analytic framework 116, one or more specialists 114, feedback collection and management system 118, storage system (e.g. data storage) 120 may be deployed so as to be accessible through a cloud-based networking environment 108. Also depicted as being accessible through a cloud-based networking environment 108, is the medical device 106 (that may include a networking capability 128), and a medical device tracking facility 602 (that may also include a networking capability 128). Communication through the cloud-based network environment 108 may include the medical device 106 providing feedback to the feedback system 118; a specialist 114 accessing the medical device 106; a medical device tracking facility 602 may track the medical device 106; the medical device tracking facility 602 and/or the medical device 106 may send or receive data to/from the storage system 120; the analytic framework 116 may interact with the medical device 106, a specialist 114, and the like.

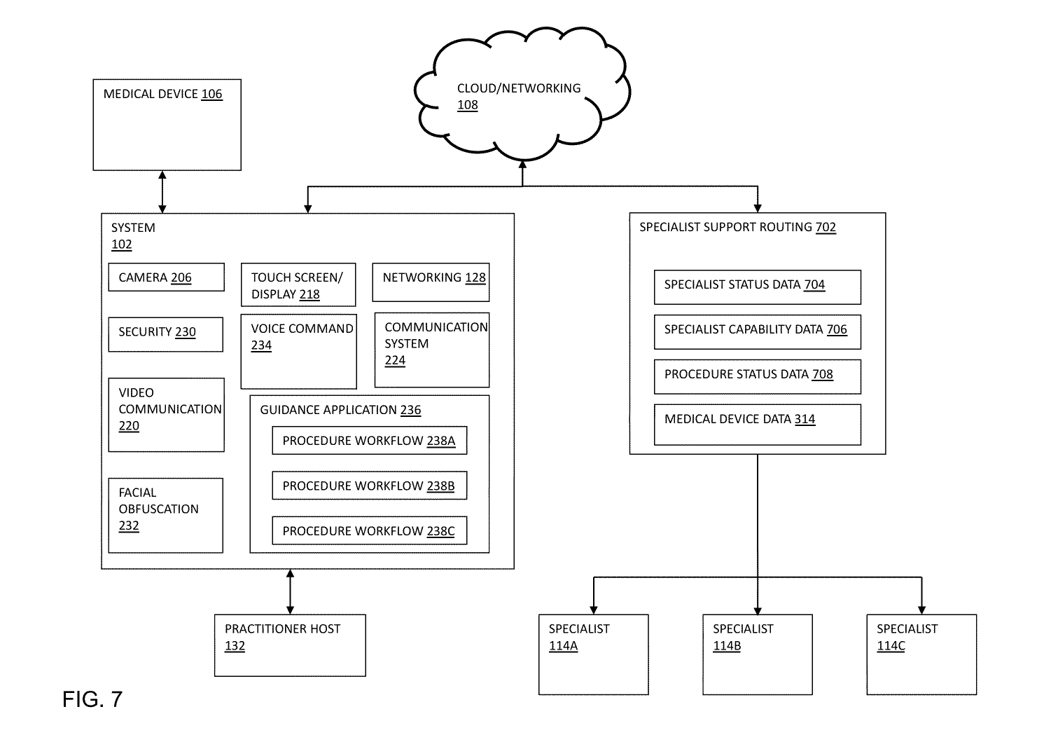

Referring now to FIG. 7, an embodiment that depicts a specialist support routing capability 702 in combination with the procedure instruction system 102 and a cloud-based networking environment 108 is presented. Specialists may be available for providing support to a practitioner host performing a procedure with the procedure instruction system 102. To ensure that specialists receive proper information about a procedure (e.g. time of procedure, practitioner information, device information, and the like) and that a specialist with the proper training and/or experience with a particular medical device 106 provides support to the practitioner, a specialist support routing facility 702 may be used. The specialist support routing system 702 may handle a variety of communication, scheduling, and related activity based on data such as specialist status 704, specialist capabilities 706, procedure status 708, medical device 314, and the like. The specialist support routing system 702 may access this and other information to contact a particular specialist (e.g. specialist 114A, 114B, 114C, and the like). The specialist support routing system 702 may continue to route information between the procedure instruction system 102 and the specialist 114 during an active support session, and or may monitor support activity during the session.

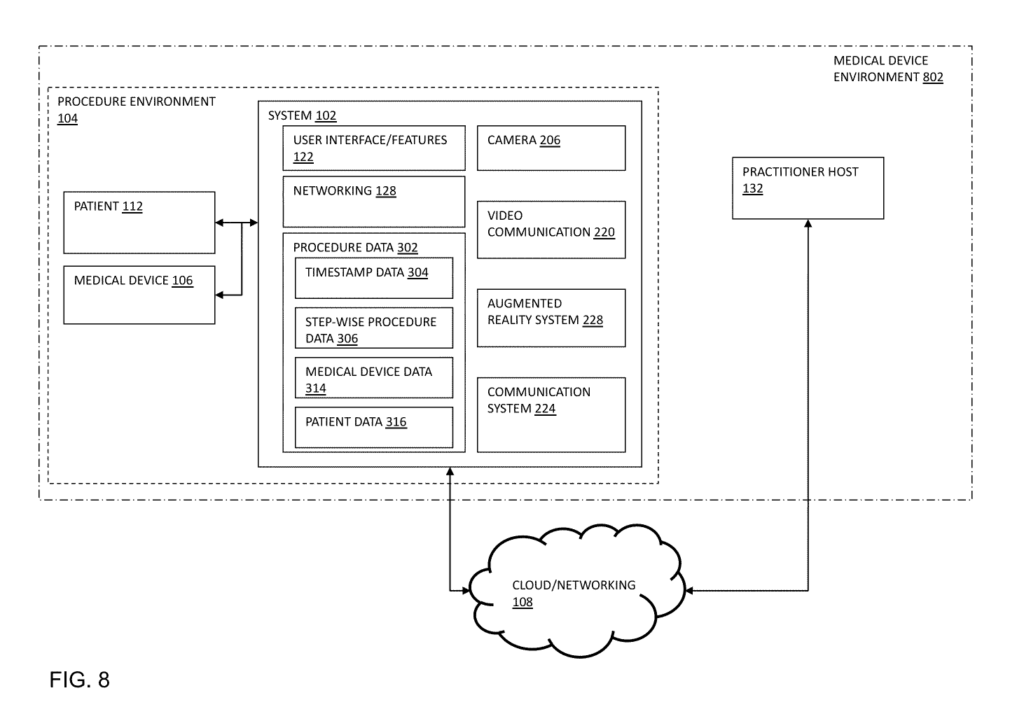

Referring now to FIG. 8, the system may provide a communications system interfacing between a medical procedure in a procedure environment 104 and a medical device environment 802, augmenting a view within the procedure environment 104 with an augmented reality facility and providing control of the augmented reality facility from the medical device environment 802. In some embodiments, the practitioner host 132 may be located in the medical device environment 802, which is a remote environment from the procedure environment 104. In one embodiment, the practitioner host 132 may be located in the medical device environment 802, which is a remote environment from the procedure environment 104, and may interface with the communications system through cloud/networking 108.

The augmented reality system 228 may provide computer-generated sensory input combined with real-world input. In embodiments, the augmented reality system 228 may combine an image associated with the procedure environment 104 with a computer generated image to be displayed on one or more of a monitor 208 and a display associated with the system. In some embodiments, the image associated with the procedure environment 104 is a video captured by a camera 206 associated with the system. In some embodiments, the computer generated image is one or more images associated with the procedure workflow 238A-C. For example, the augmented reality system 228 may combine a live video feed of the medical procedure in an operating room with one or more computer-generated images in a related procedure workflow that provides the practitioner host 132 with the instructions for the next step.

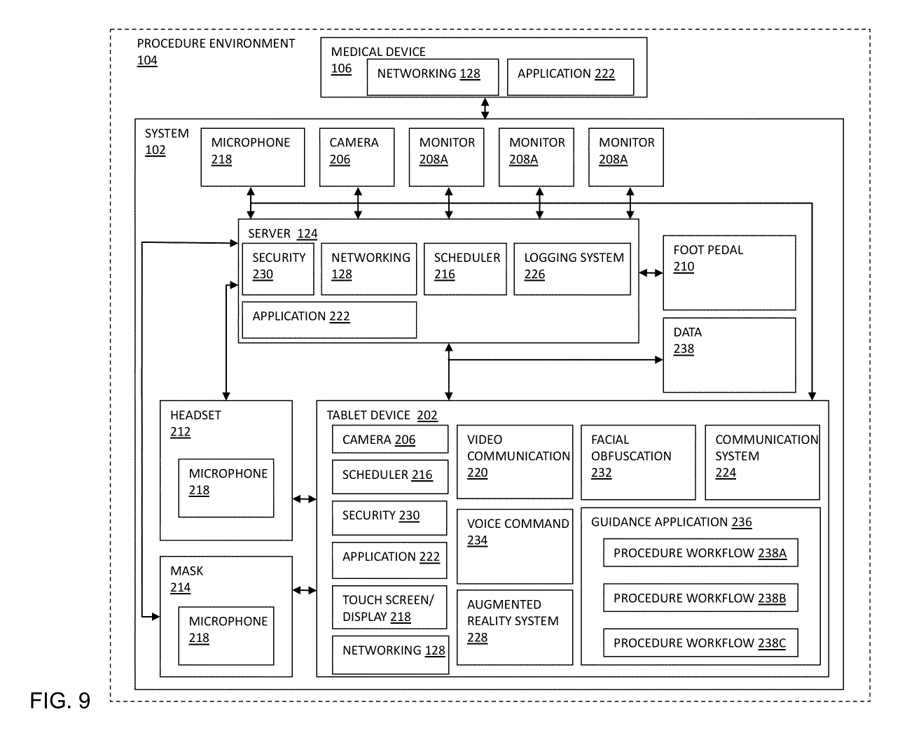

Referring now to FIG. 9, a standalone embodiment of the procedure instruction system 102 as may be deployed in a procedure environment 104 is shown. Such a system may not rely on external connections, such as may be provided through a cloud-based network or the like to access specialists, analytic frameworks, feedback systems, storage systems, and the like. The methods and systems related to using a procedure instruction system 102 in a procedure environment 104 as described elsewhere herein may be deployed on the standalone embodiment depicted in FIG. 9.

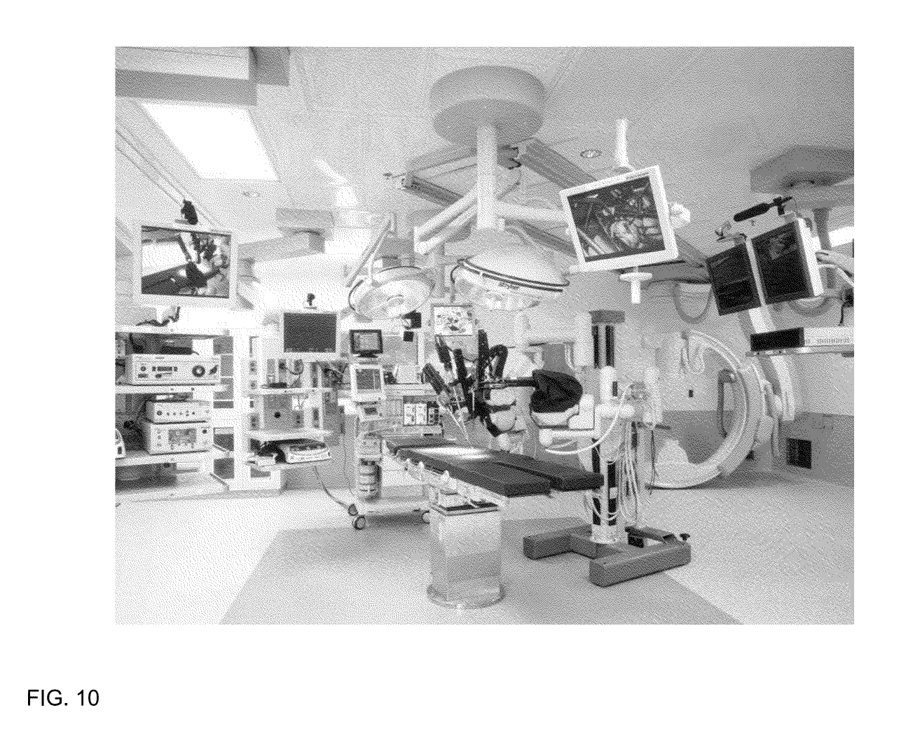

Referring now to FIG. 10, a typical deployment of the procedure instruction system 102 in an operating room is shown. The embodiment of FIG. 10 includes a plurality of procedure instruction systems 102 in an OR, such as for the anesthesiologist, the surgeon, the assistant, the nursing staff, and the like.

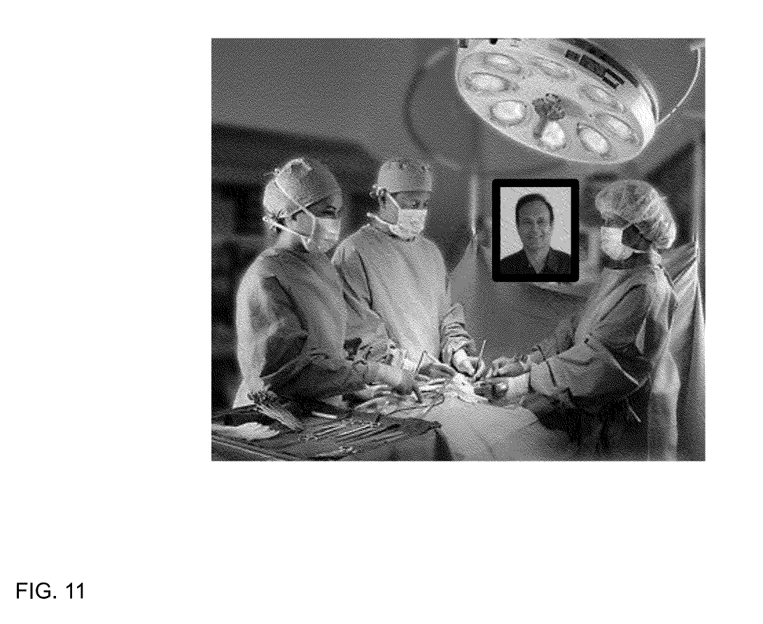

Referring now to FIG. 11, a real-time display variant of the procedure instruction system 102 in a procedure environment (e.g. a surgical procedure) is depicted. The surgeon and attendants may be able to communicate through live video communication with a specialist 114 who may provide advice, guidance, and/or answer questions about a procedure that may be associated with a medical device with which the specialist is an expert.

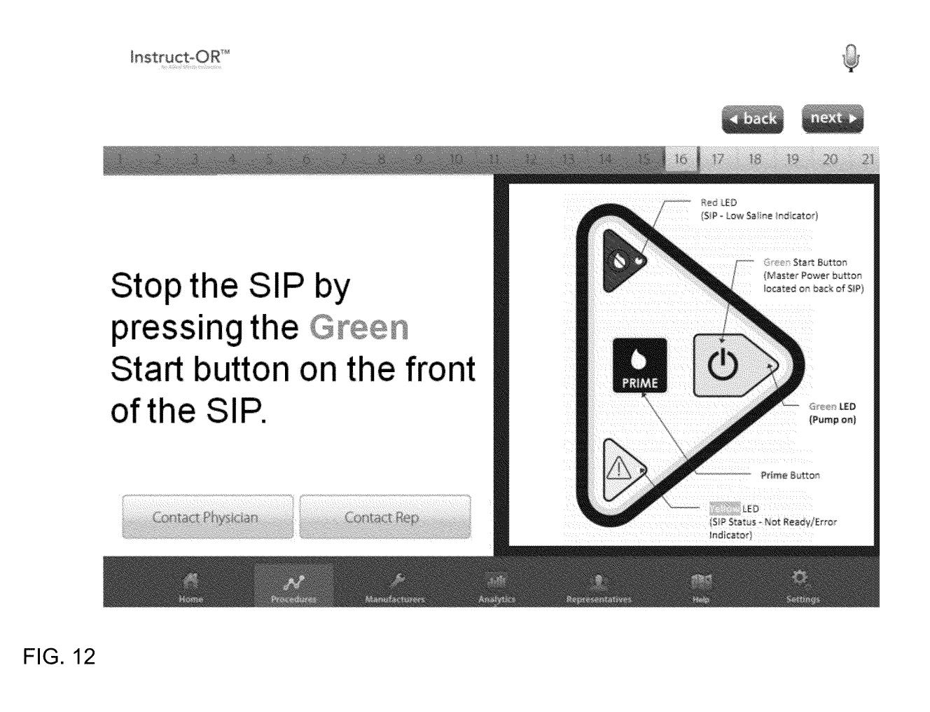

Referring now to FIG. 12, a representative display that includes procedure instructions and one or more annotated images of a medical device is depicted. Such a display may be presented as a part of a procedure workflow 238 and may be associated with a particular step in the workflow. Alternatively, such a display may be provided in response to a practitioner request for assistance with an aspect of the medical device he/she is using. Other scenarios for presenting such a display can be readily envisioned and are contemplated herein.

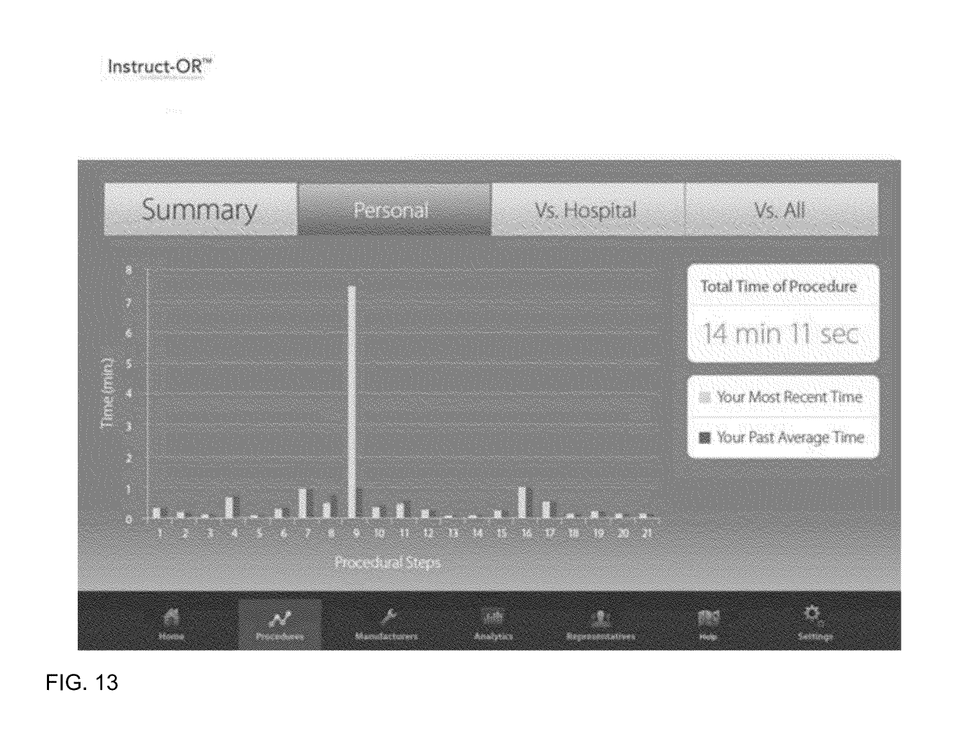

Referring now to FIG. 13, a representative display of a bar graph of time required for steps in a procedure workflow is presented. The specific embodiment of FIG. 13 is a personal practitioner's time for completing steps in a procedure. In addition to a personal practitioner's time bar graph, similar graphs may be presented for comparison to a specific hospital (e.g. the hospital in which the procedure is being performed) or to all previously captured data for the same procedure that was performed prior to the current procedure.

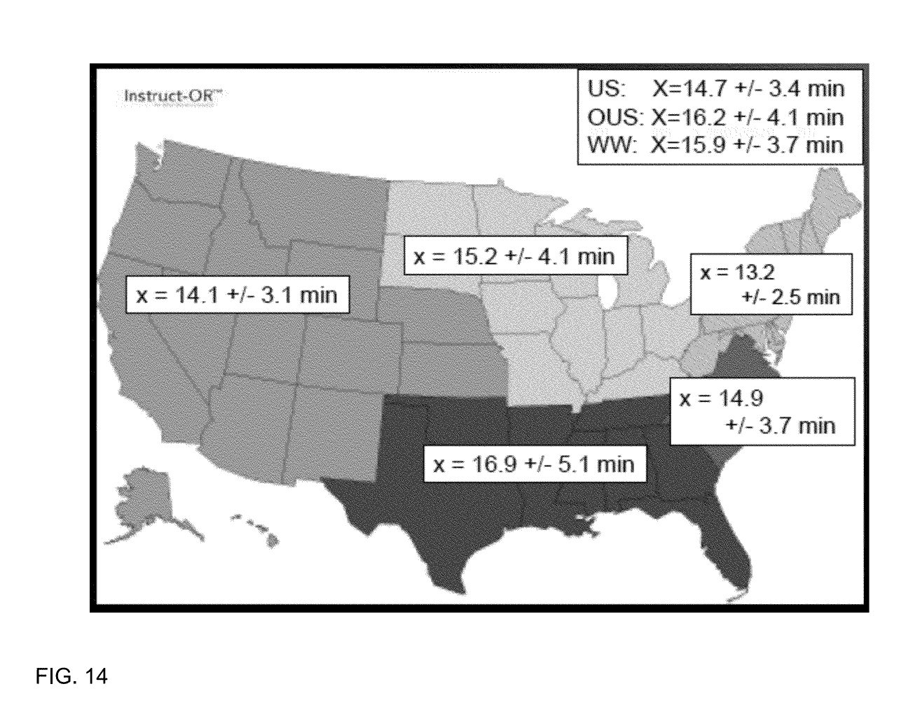

Referring now to FIG. 14, an analytic framework 116 may be used to determine, such on a regional basis, procedure execution time and variance (e.g. standard deviation, and the like). This representation of data collected from a plurality of executions of one or more procedures may be quite helpful to a medical device company. For example, a device manufacturer might determine what versions of a device are easiest to use or most effective, what features of a device of a device are most difficult to use (such as based on the time it takes to complete a step using the device), and the like. A hospital, health maintenance organization, or the like can track practitioners, such as determining which practitioners require more time to complete procedures, or certain steps of procedures, such as to suggest additional training, revisions to procedures, or the like. Thus, the analytic framework 116 may provide a facility for review and analysis of step-by-step data as to the timing and effectiveness of procedures, and of devices used to complete procedures, as well as analysis of related data, such as collected by information technology systems present in the environment in which a procedure takes place.

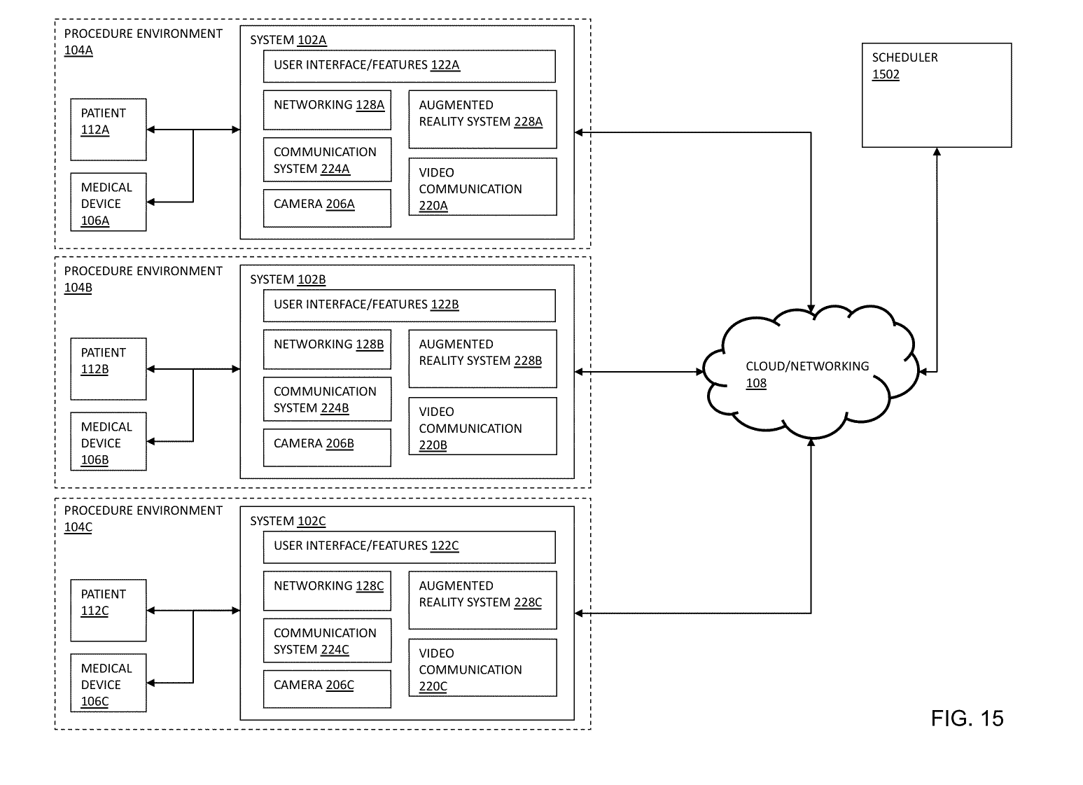

Referring now to FIG. 15, a plurality of procedure instruction systems 102A-C may connected via a network 108. Each procedure instruction system 102 may be located in a separate procedure environment 104, and associated with a patient 112 and a device, such as a medical device 106. For example, each system 102 may be located in a separate operating room, where each operating room has a different patient 112A-C undergoing surgery with a unique medical device 106A-C. As described above, each system 102 may have a user interface 122, networking 128, communication system 224, camera 206, augmented reality system 228, and video communication 220. In some embodiments, the plurality of procedure instruction systems 102A-C may be connected to a scheduler 1502 via the network 108.

As also described above, each system 102 may connect to the network 108 via a networking 128 and to each other over the network 108. Networking a plurality of systems 102 may permit a user of a first system 102A performing a procedure to notify a user of a second system 102B, for example, to inform the second user that the procedure, or a step in the procedure is almost complete, is complete, is not going to be completed, or the like. Thus, a series of steps that require action by different users may be executed under guidance that is coordinated centrally and presented by multiple tablets or other interface devices to multiple users who are participating in the execution of the procedure. Similarly, multiple procedures, such as two different operations, may be coordinated by reporting the status of one procedure to facilitate another one. For example, a report on the completion of certain steps of a procedure may allow prediction of the time remaining in that procedure, which may be reported to staff who will execute a later procedure, the commence of which will be based on the timing of completion of the earlier procedure. The completion and reporting of certain steps of a procedure may also indicate needs for re-stocking supplies, or re-scheduling or re-locating another procedure.

In one embodiment such systems interact with the scheduler 1502. The scheduler 1502 connected to the network of systems 102A-C may be enabled to receive time log information from the systems 102A-C. In embodiments, the schedule 1502 may also be enabled to receive completion time information from the systems 102A-C. In embodiments, the completion time information may be an actual completion time, a scheduled completion time, a projected completion time, or some other time. The scheduler 1502 may, in response to information from the systems 102A-C, schedule a resource for use in connection with one or more systems 102A-C. For example, the scheduler identify a resource needed for each of the procedures planned for patients 112A-C, and schedule the procedures so that the procedure in environment 104A get the resource first and is done with the resource before the procedure in environment 104B needs the resource, which is, in turn, done with the resource before the procedure in environment 104C needs the resource.

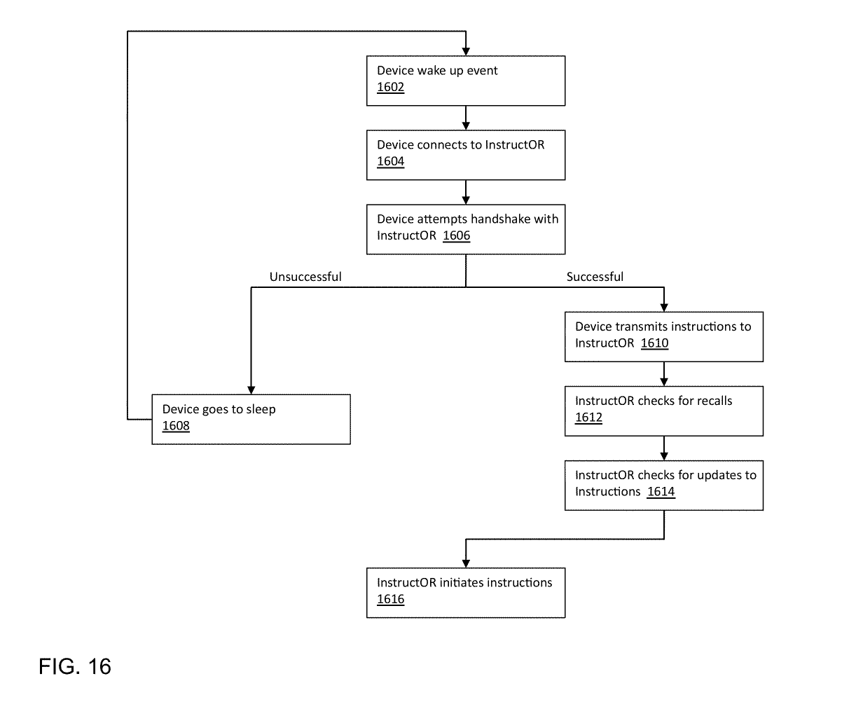

Referring now to FIG. 16, a workflow for updating a procedure instruction system in response to an instruction from a medical device may include waking up the device 1602, connecting the medical device to the system 1604, attempting a handshake with the system 1606, transmitting the instruction to the system 1610, checking for device recalls 1612, checking for updates to the instruction 1614, and initiating the instructions on the updated system 1616. Waking up the device 1602 may include one or more of opening the device packaging, powering on the device, and an automatic wake up event (e.g. the device may wake up in response to a movement). Connecting to the system 1604 may be accomplished over a networking 128 in the device. The device may attempt a handshake 1606 using a networking protocol (e.g. TCP). In some embodiments, if the device may go to sleep 1608 if the handshake with the system fails. In response to successfully completing the handshake, the device may transmit an instruction to the system 1610, for example, over FTP.

In response to receiving the instruction, the system may check the update for problems. Checking for problems may include checking for device recalls 1612, for example, by connecting to the device manufacturer's server for device information. Checking for problems may include checking the instruction for updates 1614. For example, the system may connect to an application server hosted by the device manufacturer; pass an identification number associated with the device to confirm that the instruction from the device is current; and, if it is not, to download the current instruction. Once the system has the current instruction, it may initiate the current instruction. In embodiments, the instruction may be a step-by-step workflow with multiple instructions.

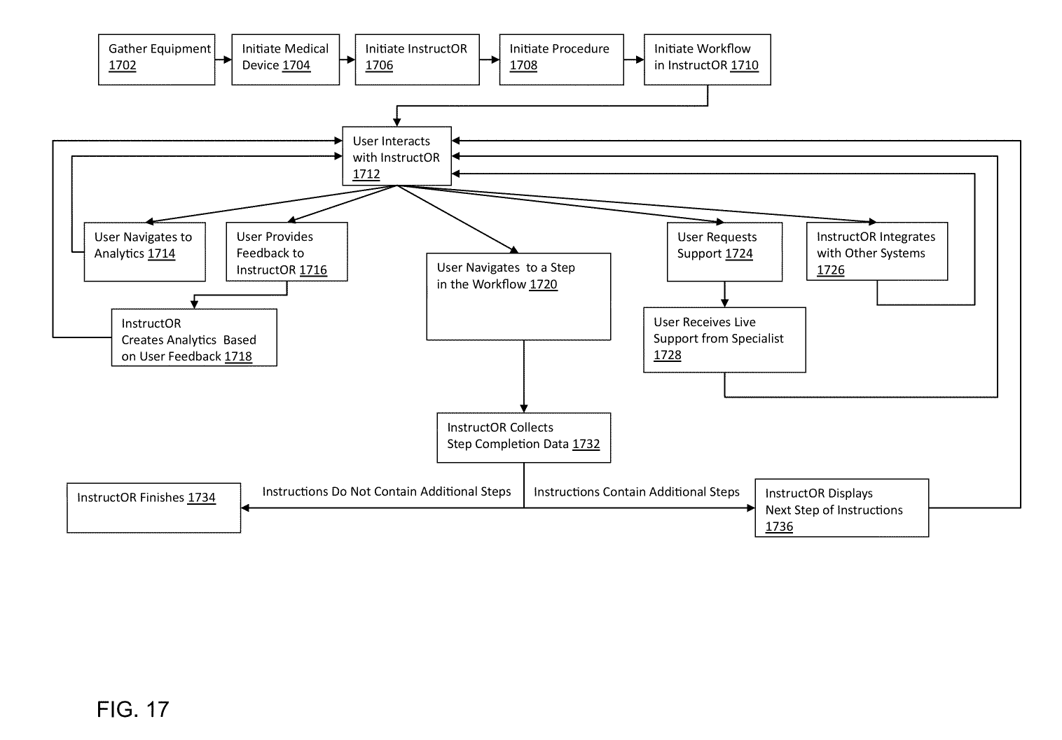

Referring now to FIG. 17, a workflow for using a procedure instruction system to guide a user in a step-by-step guidance associated with a medical procedure may include initiating the system 1706, interacting with the system by a user 1712, navigating through one or more steps in a workflow 1720, and finishing the workflow 1734. In some embodiments, the user may be a practitioner host.

In embodiments, there may be some preliminary steps for using the system to guide the user in the step-by-step guidance, such as, gathering equipment 1702 for use in connection with the medical procedure, and initiating a medical device associated with the medical procedure 1704. Gathering equipment 1702 may include, for example, obtaining and sterilizing equipment, such as scalpels, clothing, pumps, masks, meshes, tables, and other equipment. Initiating the medical device 1704 may include waking the device up, powering on the device, starting an operation of the device or some other initiation. Initiating the medical procedure 1708 may be another step that, in some embodiments, is performed before interacting with the system. In some embodiments, the user's initial interaction with the system is to initiate the step-by-guidance on the system 1710. For example, initiating the step-by-step guidance 1710 may include selecting a medical procedure and starting the first step in the procedure.

Once the system is initiated, the user may interact with the interface of the system to control and interact with the system 1712. The interaction may be one or more of, a voice command, an input from a peripheral (e.g. from a foot pedal, from a pointing device), a gesture, a motion, a tactile input, or some other input. The interaction may be a navigation. The user may navigate to analytics 1714, for example, to review the user's performance against other users or to review an analytics report. From there, the user may interact with the system 1712, for example, to return to the step-by-step guidance. The user may interact with the system to provide feedback 1716. In response to receiving feedback, the system may analyze the feedback 1718. The user may request support 1724. For example, the user may request live video support from a support specialist supporting a medical device associated with a medical procedure. In response to the user's request for support 1724, the user may communicate with the support provider 1728, for example the specialist, and then navigate back to the step-by-step guidance. In some embodiments, the user may navigate back to the guidance simultaneously while communicating with the support provider. In embodiments, the system may connect with one or more other systems in response to a user input. For example, the user may power up a medical device for use in a medical procedure and connect the device to the system. In this example, the system, in response to the user connecting the device, may send a notification to a hospital inventory system stating that the device has been removed from inventory and a notification to the device manufacturer's invoice system so that the device manufacturer prepares an invoice for the used device.

In embodiments, the user may navigate to a step in the step-by-step guidance 1720. In embodiments, the navigation may be linear, such as moving to the next step in the guidance as the preceding step is completed. In some embodiments, the user may also be able to navigate backwards in the step-by-step guidance, for example to review a prior step, to complete a missed step, or to change the order in which a step is performed. In some embodiments, the user may be able to navigate non-linearly. For example, the user may be able to navigate to a step that is 5 steps ahead, then back to a steps that is 3 steps behind. This may be desirable for a user who is reviewing the steps, for example, in preparation for a difficult surgery or while studying for a certification exam.

The system may record, upon completion of a step in the step-by-step guidance, the user's performance 1732. For example, the system may record the amount of time the user took to complete the step. If there are no additional steps in the step-by-step guidance, the system may complete the guidance 1734. If there are additional steps, the system may proceed to the next step in the step-by-step guidance 1736.

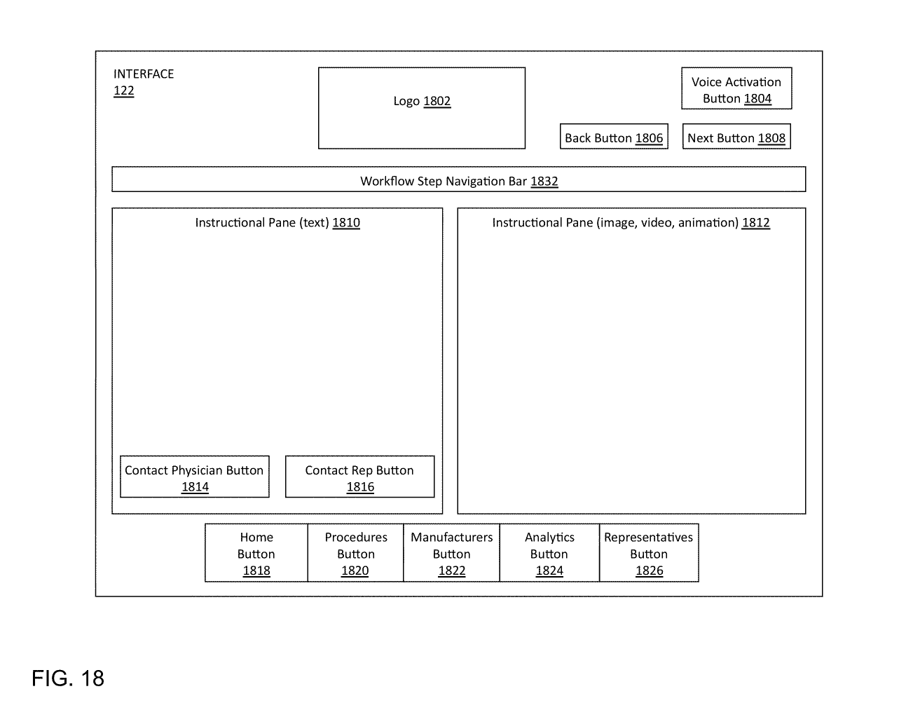

Referring now to FIG. 18, an interface 122 for the system may include one or more of branding, navigation, and content elements. The branding element may be a logo 1802.

The interface 122 may comprise one or more navigation element. In some embodiments, the navigation elements may include back 1806 and next buttons 1808. The user may, for example, use the back button 1806 to return to the prior step in the workflow and the user may use the next button 1808 to navigate to the next step in the workflow. The workflow step navigation bar 1832 may be another navigation element. The workflow step navigation bar 1832 may present a representation of the steps or a subset of the steps in a workflow by which the user may navigate to a particular step in the workflow. The interface 122 may also provide a voice activation button 1804. In embodiments, the user may select the voice activation button 1804 in order to toggle the voice command functionality.

Other navigation elements may, such as, a home button 1818, a procedures button 1820, a manufacturers button 1822, an analytics button 1824, and a representatives button 1826, may be provided by the interface 122. In embodiments, the interface 122 may exit the current procedure and return to a main screen in response to the user selecting the home button 1818. The user may navigate to a list of available procedures by selecting the procedures button 1820, for example to select the step-by-step guidance to load. The user may navigate to a list of available manufacturers by selecting the manufacturers button 1822, for example, to browse a list of supported devices listed by manufacturer. The user may navigate to the available analytic reports by selecting the analytics button 1824. The user may navigate to a list of representatives by selecting the representatives button 1826, for example to see which representatives support which devices. The user may also select a contact physician button 1814 and a contact rep button 1816. The contact physician button 1814 may initiate a request from the user to communicate with an available physician to request information. For example, a surgeon in the middle of a surgical procedure may select the contact physician button 1814 in order to ask a question of the patient's primary care physician. Similarly, the contact rep button 1816 may be used by the user in order to initiate a communication with a support rep, for example to receive support from the device support specialist.

The interface 122 may also include one or more content panes. In embodiments, the interface 122 may present two instructional panes 1810 and 1812. In some embodiments, one instructional pane (text) 1810 may be adapted to present instructional text (e.g. a text version of a DFU). In some embodiments, the second instructional pane (image, video, animation) 1812 may be adapted to present visual content (e.g. images, video and/or animation).

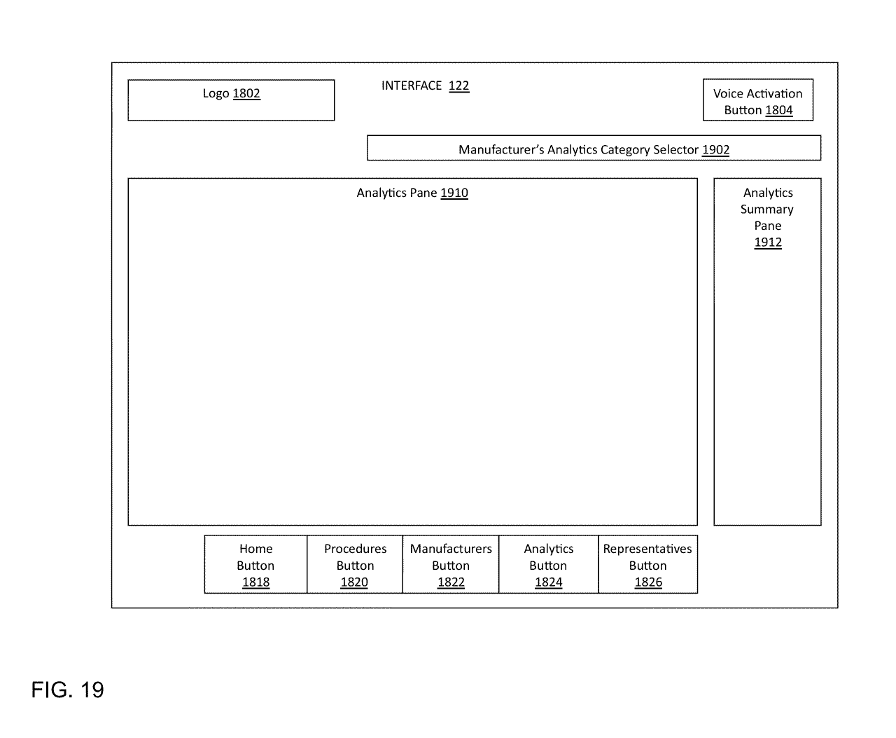

Referring now to FIG. 19, the interface 122 may be adapted to provide analytics reports. In embodiments, the analytics reports are provided by a manufacturer, such as a medical device manufacturer. The interface 122 may be adapted to display a manufacturer's analytics selector 1902. The user may use the manufacturer's analytics selector 1902 to select a particular report.

In some embodiments, the interface 122 may provide one or more analytics content panes 1910 and 1912. In embodiments, the interface 122 may provide an analytics pane 1910 for presenting a report to the user. In embodiments, the interface 122 may provide an analytics summary pane 1912 for presenting highlighted data in the report to the user. In some embodiments, the highlighted data may be highlighted based on a selection of the user. For example, a user may select a report that displays the time taken per step by the user in a recent procedure and compares the times against other users. In this example, the user may select a particular step in the analytics pane 1910 and, in response to the selection, the analytics summary pane 1912 may present one or more of the time taken by the user, the average time taken by users, a legend, or some other information.

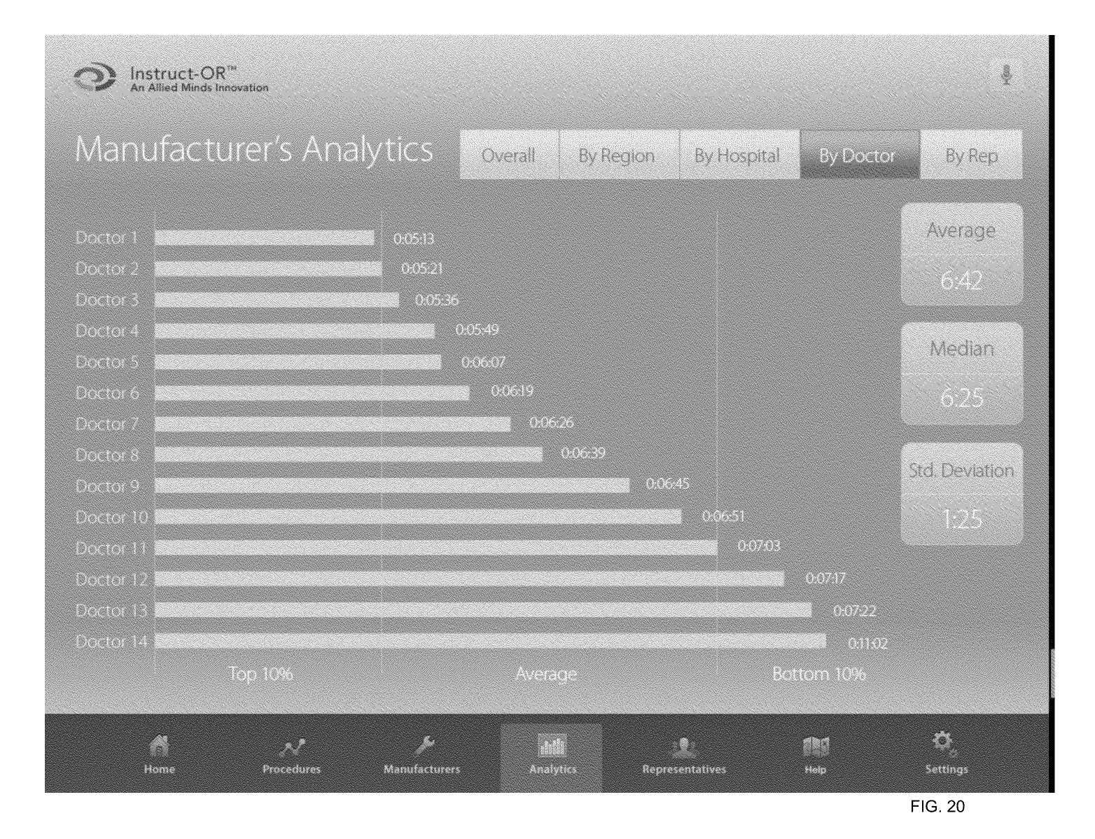

In some embodiments, analytics may be provided for viewing one or more user's times. By way of example and referring to FIG. 20, a plurality of doctor's times for a particular procedure or use of a device in a procedure, and the like may be provided to another, such as a manufacture, a manufacturer of the device, and the like. In embodiments, a plurality of doctor's times may be monitored, and any one or more of the average, median and standard deviation of times may be displayed to another such as a manufacturer. In embodiments, this may quickly allow the manufacture to identify outliers. In embodiments, this may allow the identification of issues with a device, a procedure, a doctor, and the like. In embodiments, the analytics may provide for ranking the user compared to others, against a standard, and the like. In embodiments, the user may be placed in a percentile, such as top 10%. In embodiments, the user may be ranked as average, in the bottom 10% percent, and the like. In embodiments, analytics may be provided by representative, by doctor, by hospital, by region, overall, and the like.

Additional various methods and systems of a procedure instruction system are herein after described.

Architectural and/or structural components and/or modules associated with a procedure instruction system as described herein may include a tablet device in an Operating Room (OR) with an in-OR user interface, touch interface, video and voice interface and the like. This aspect may further include a video player and the user (e.g., the practitioner host or the surgeon) may configure the size of the video player depending on the specific requirements. For example, the practitioner host may reduce or increase the size of the video player available on the tablet device while providing additional information to the specialist. This aspect may further allow the user to change the brightness of the display of the video player. This aspect may further include one or more user interfaces such as a touch based interface including gesture based touch interface, a voice based input interface, various input peripherals, gesture based user interface (e.g., gesture captured using a camera or a glove), holographic human-machine interface, a sensor-enabled glove to detect movement of a hand, a tactile based glove, glasses mounted device interface, digital contacts with feedback like date monitor, and the like.

This aspect may further include a help section such as to provide assistance to the user for enabling live video interaction with a support specialist for the medical device. The help section may include an option such as to contact the support specialist to receive feedback on a particular medical procedure. The help section may further provide user options such as to read instructions on the medical procedure, watch video, hear audio on the procedural steps and the like.

This aspect may further include the tablet device in a client server configuration. The tablet device configured as a client may communicate with the server such as to enable live video interaction with a support specialist for the medical device. The user may request the tablet device to perform one or more operations (e.g., contact the specialist or provide guidance regarding a medical procedure) and the tablet device may communicate the request to the server. Accordingly, the server may access one or more databases to retrieve the information associated with the request and may transmit to the tablet device. This aspect may further include the tablet device in a standalone configuration. In this aspect, the tablet device may be configured to store the relevant contents within the memory. On receiving the request from the user, the tablet device may extract the information associated with the request from the memory and display on the interface.

This aspect may further provide the user an access to multiple videos and/or animations simultaneously. The user may control (e.g., play, stop, maximize, minimize, mute and the like) the multiple videos and/or animations while live video interaction. For example, on one side, the user may interact with the specialist through a video chat for a medical procedure and, on the other side, the user may access the video and/or animation providing details of the medical procedure. This aspect may further provide the user an access to control screen real estate depending on the requirements. This aspect may further use the iPad as a controller such as to control the display of the tablet device. This aspect may further include providing multiple perspectives for the video and the user may switch between them.

This aspect may further include protection, such as plastic shield protection for the system and/or the users, or flexible plastic covering, such as a plastic bag. This aspect may further include a sterilized system suitable for use in an OR.

Architectural and/or structural components and/or modules associated with a procedure instruction system as described herein may further include real-time network communication among equipment in an OR, a host (e.g. practitioner host), and a specialist. This aspect may further include live video chat/conferencing; SMS or other messaging; serving audio and/or video images or animation and the like to the OR; serving audio and/or video from the OR to a remote location.

Architectural and/or structural components and/or modules associated with a procedure instruction system as described herein may further include a specialist user interface with live video interfacing and procedure tracking information. This aspect may further include context aware information based on real-time procedure information; pre-populated interface with contextual information; and specialist signaling capability as the supported procedure starts.

Architectural and/or structural components and/or modules associated with a procedure instruction system as described herein may further include a primary content that may include a procedures module for storing, managing, serving procedure data, and the like. This aspect may further include allowing modification of procedures based on optional steps in IFU that may include procedures for a surgeon, procedures for a hospital, procedures for separate members of the team (scrub technician, circulator, and the like). An actual IFU is available when required (the actual FDA IFU). The IFU described herein may include a language selection option. This aspect may further include customizing a procedure. The procedure may be customized online and send to the iPad. The procedure may be customized within a range of allowed possible customizations. The procedure may be customized based on a preference card of a physician (such as for example “what you need and when you need it for a procedure”). The procedure may be configured such as to provide configuration to patient.

This aspect may further include storing information about what is going to be needed next such as for the circulator (who has to know what you are going to want next based on the procedure)—e.g. the circulator may need to get blue dye when the surgeon goes to the next step. This aspect may be displayed as a sidebar (e.g. like “what's next” on ESPN's SportsCenter). This aspect may further include a “Time out”—the checklist of what is done in the OR provided before a procedure or during a waiting period during the procedure—which may be logged. This aspect may further include branched procedures such as based on things the surgeon finds out during surgery. This aspect may further include branched guidance for the user. The branched guidance may include providing video and/or animation preview to the user such that the user may choose an appropriate branch, or so that an appropriate branch may be provided to a user based on information, such as information collected during a procedure (e.g., patient data), sensor information, information about the device, information about the duration of steps taken so far, input from the remote specialist, or the like. Further, the device may provide suggestion(s) to the user (e.g., host practitioner) regarding the applicable branch. For example, it may happen that during the surgery a tool, such as a pump, may break and this aspect may provide the appropriate branch of fixing the broken tool (e.g., “here is how to fix the broken pump”). In another example of branched guidance, this aspect may further provide guidance depending on the types of fluids involved. For example, the user may be guided on the drainage of fluids depending on the types of the fluids. Accordingly, the user (e.g., the doctor, host practitioner) may select the desired path based on the displayed examples of the branched guidance. This aspect may further include listing of the suggested one or more branches (e.g., ways to drain a fluid, broken port mid-procedure, change video view based on mapping of patient and the like) in the medical procedure. In another example a patient's condition may be assessed during a procedure, such as to confirm that successful completion of a difficult step. Upon such completion one branch of the instruction may guide completion of the procedure, while another branch may guide appropriate revision for situations in which the difficult step was not successfully completed, or return for the completion of such steps (e.g., completion of the ablation of tissue that is required for a particular step, completion of lavage of an area, or the like).

This aspect could be for procedures that do not include a medical device. This aspect may further include optional steps in a given procedure (such as for example irrigation), modify the order of some steps, modify how some steps are performed, and/or add new steps (e.g. using a marking pen to mark the hernia mesh in the middle to keep it symmetric). This aspect may further include a device to provide feedback on modifying steps such as to notify a doctor that proposed modifications are not acceptable, to identify optional/modifiable steps, and the like. This aspect may further include notifying users regarding the flipped/reversed steps. This aspect may further include sending modified and/or added steps back to the manufacturer.

Architectural and/or structural components and/or modules associated with a procedure instruction system as described herein may further include a secondary content. This aspect may further include use of downtime within a procedure that may include running through steps that are coming up, taking a survey or presenting other data, marketing/advertising, recording feedback from surgeon, and the like.

Architectural and/or structural components and/or modules associated with a procedure instruction system as described herein may further include separate OR server within the OR that connects to the cloud and drives the various system components for the overall system such as on an electronic cart enabled to communicate with an interface device, such as a tablet, enabled according to the methods and systems described herein.

Architectural and/or structural components and/or modules associated with a procedure instruction system as described herein may further include a data integration/synchronization module (e.g., synching between OR and other system). This aspect may further include a separate OR server within the OR that connects to the cloud and drives the various system components for the overall system (voice, video, iPad(s), and the like). This aspect may further stream data and/or content from the server. In an example, this aspect may support data streaming for distributed functionalities (e.g., transmission, processing and tracking of the patient monitoring signals, receiving inputs from the specialist in form of audio and/or video signals, and the like). This aspect may further include synchronizing to a monitor. In an example, the synchronization module may synchronize data for a wearable monitor (e.g., eye ware type monitor). This aspect may further include providing feedback based on one or more of the location, position, angle, and movement of the device, or one or more of the location, gesture, position, angle and movement of the user. For example, finger cots may be used for tracking the fingers. This aspect may include a C-arm for generating 3D image of the device or the user's hands inside the patient's body. Accordingly, this aspect may include synchronizing to a hologram (e.g., the 3D image of the device or the user's hand).

This aspect may further include synchronizing to another iPad (such as one for the circulator to look ahead in the procedure from a different view point). This aspect may further include list of steps that are coming up next. This aspect may further include product out of bag that loads the application that is associated with the device. This aspect may further include integrating with other device and/or teams such as to provide relatively more information to the user. For example, this aspect may integrate data (e.g., biopsy report or an updated medical procedure) obtained from a pathology team on one or more aspects of the patient or the medical procedure. This aspect may further include data integration with magnetic resonance imaging (MRI) scan related data and/or medical records such as to assist the practitioner to examine current parameters of the patient.

Architectural and/or structural components and/or modules associated with a procedure instruction system as described herein may further include data storage. This aspect may further include cloud, virtual server, local server, remote server, hospital server (such as for example, customization data, surgeon metadata, copy of procedural data from device manufacturer, recorded data/logs, analyzed/aggregated data, and the like), device manufacturer server (such as for example, procedural data), and the like.

Architectural and/or structural components and/or modules associated with a procedure instruction system as described herein may further include a scheduler. This aspect may further include specialist availability per procedure. This aspect may further include a scheduler for what IFUs are being used in what ORs today such as downloading IFUs at the beginning of each day. This aspect may further include clearing out IFUs at the end of the day. This aspect may further include updating and optimizing schedules for resources (e.g. operating rooms) based on the schedule start times, the expected completion times, and the actual completion times. This aspect may further include flagging when the resource (e.g., person, room, equipment, and the like) is available and to provide the alerts to the resources regarding the schedule. This aspect may further include networking InstructORs to coordinate schedules and alerts (e.g. in manufacturing, preparing station 2 for output from station 1). This aspect may further include providing artificial intelligence (AI) or learning within the network.

This aspect may further include for equipment to be used in connection with the procedure, in addition to the device such as including optional equipment (e.g., irrigation), forecasting/prompting for circulator, and the like.

These architectural and/or structural components and/or modules associated with a procedure instruction system as described herein may further include procedure information database and communications with data for various devices and procedures.

Architectural and/or structural components and/or modules associated with a procedure instruction system as described herein may further include a tracking module with a logging database for logging information about performed procedures.

Architectural and/or structural components and/or modules associated with a procedure instruction system as described herein may further include analytic workbench for storing and analyzing data from procedures.

Architectural and/or structural components and/or modules associated with a procedure instruction system as described herein may further include a importing/parsing module. This aspect may further include importing an IFU and rendering it in a convenient electronic package. This aspect may further include using an IFU template. This aspect may further include a text-to-audio module such as to assist the user.

Architectural and/or structural components and/or modules associated with a procedure instruction system as described herein may further include voice handling/recognition system. This aspect may further include array of microphones, a speech enabled software application configured to provide real-time, in OR guidance on the use of the medical device and a voice controlled in OR tablet. This aspect may further include artificial intelligence (AI) and/or learning such as to guide the host practitioner using the voice. This aspect may further include operating a tablet entirely by voice recognition within the OR. This aspect may further include wake up on commands such as to activate the tablet device. For example, a common language capable application in combination with one or more voice commands may be provided such as to medical guidance to the practitioner. This aspect may further include headsets (such as for example, Bluetooth, wireless, wired, multiple inputs (such as Jawbone), and the like), microphones in a mask and/or microphone(s) on a collar. In an example, this aspect may provide disposable microphones in the mask that may be adapted to receive voice recognition for a speech-driven or workflow. The microphone may be adapted to receive voice recognition commands. This aspect may further include filtering technologies (such as for example signal processing), a mask wired to the rest of system or wireless, excluded from sterile field, can mute inbound audio, but will not stop recording audio.

Architectural and/or structural components and/or modules associated with a procedure instruction system as described herein may further include video communications system. This aspect may further include an iPad having just a display. The display may not have much input/output capability (single input and single output). Thus, it is hard to make it interactive in general ways, but good for what it does (hold it, show the screen display, and use the camera). The display described herein may be too small. This aspect may further include video conferencing vs. video communications. This aspect may further include facial obfuscation (such as for example on a patient).

Architectural and/or structural components and/or modules associated with a procedure instruction system as described herein may further include leveraging the set-up of monitors that are already in most ORs.

Architectural and/or structural components and/or modules associated with a procedure instruction system as described herein may further include communication band (e.g., wired, wireless).

Architectural and/or structural components and/or modules associated with a procedure instruction system as described herein may further include content creation tools. This aspect may further include templates such as to provide consistency over procedures, look and feel, and the like. This aspect may further include parsers. This aspect may further include a tool set for allowing manufacturers to create content such as IFU templates. This aspect may further include the primary content, the secondary content, and the like.

Architectural and/or structural components and/or modules associated with a procedure instruction system as described herein may further include a scrub station. This aspect may further include a device for preparing for a procedure. The device for preparing for a procedure, as described herein, may further include reviewing steps, testing the Instruct-OR system, loading the data/IFU, and the like.

Architectural and/or structural components and/or modules associated with a procedure instruction system as described herein may further include patient post-procedure instructions. This aspect may further include what to expect post-procedure. This aspect may further include communicating with the patient via email, printed copy, text/SMS, and the like.

Architectural and/or structural components and/or modules associated with a procedure instruction system as described herein may further include post-procedure follow up for surgeon. This aspect may further include procedure reports for medical records. This aspect may further include billing procedures.

Relationship among components/modules associated with a procedure instruction system as described herein may further include fully networked system with robust data security. This aspect may include SaaS (Software as a Service), cloud model, and the like. This aspect may further include a transaction module such as for use in micro-transaction-style market. This aspect may further include broadband network such as for example wired, wireless, LAN, WAN, and the like. This aspect may further include removing IFUs and other data periodically (such as for example, at the end of the day and the like, to reduce risk of data loss via iPad theft).

Data/communication/analytics/reporting aspects associated with a procedure instruction system as described herein may include communications that may include live video communications from the OR to a specialist in the device and procedure. This aspect may further include projecting video communication versus video conferencing, and that may include projecting videos from the OR or into the OR. This aspect may further include telephony, live communication and obfuscated recording. This aspect may further include obfuscated patient identity that may include embedded algorithm which de-identifies all faces (pixelator)—such as facial obfuscation (for example, as a component of HIPAA compliance). This aspect may be based, in part, on the nature of the recording or communication, and might be based on the consent of the individuals in the OR. This aspect may further include peripherals that may include wired, wireless, microphone(s), remote control, additional displays, a sensor-enabled glove to detect movement of a hand and the like such as to provide real time location guidance to the host practitioner, foot pedal, cameras such as room camera, a camera on an e-cart, a camera on a light source, a camera on a surgeon, a camera used in connection with a pointing device, a camera capable of capturing gesture, motion, position analysis, a C-arm for determining the position of a sensor (e.g. on the device, the user's hands, etc.) while the sensor is inside something (e.g. the patient's body). This aspect may further include the sensor to be attached to the user, device, equipment (e.g., to a microphone in a mask) and the like. This aspect may further include attaching the sensor through a wired or a wireless connection. This aspect may further include a biofeedback sensor that may generate heat or vibration on detection of any abnormality.

This aspect may further include voice capture that may include headset (e.g. a Bluetooth headset), a microphone from the ceiling, a microphone for signal processing (e.g. for unique voice recognition among group of voices in order to recognize who is the doctor). The attachable microphone/combination video recorder described herein may record what the surgeon is seeing, record multi-plex video, record from the light=source handles (e.g. recording what the light is focused on), recording based on tracking a light (e.g. recording where the light is placed) and the like.

Data/communication/analytics/reporting aspects associated with a procedure instruction system as described herein may include logging/recording. This aspect may further include logging of steps taken by the voice interface. This nature of this aspect might be based on what kind of consent you have regarding the video recording. This aspect may further include video recording/logging for quality assurance that may include addressing legal discovery standards, comparing a library of successful procedures, reviewing for mistakes, and the like. This aspect may further include documenting the number of times a doctor used a particular procedure (e.g. for medical boards and societies), logging feedback from a surgeon, logging the timeout activities, and the like. This aspect may further include recording of additional equipment used that may include beginning log/record process upon taking equipment out of a box, automatically logging unboxing events, and the like. This aspect may further include timing the procedure. The procedure may include a number of steps. This aspect may further include logging time-stamped information about each step undertaken during the procedure by the professional using the medical device on the patient. This aspect may further include storing images with directions.

This aspect may further include logging patient-related data that may include patient disposition, patient disease/status discovered during a procedure, patient location, room number, outpatient status, contact information for patient's physician (such as for example, for follow up purposes).

Data/communication/analytics/reporting aspects associated with a procedure instruction system as described herein may include display. This aspect may further include in-OR touch display such as a tablet (for example, an iPad or an Android tablet), and the like. This aspect may further include displaying video such as using existing OR cameras or an optional audio/video system. This aspect may further include animation/graphics displayed in a larger OR monitor. This aspect may further include a system for guiding multiple users in the procedure where the system may include a plurality of screens to present different steps that are relevant to the procedure to a plurality of users. As a result, different users may perform the tasks corresponding to their steps of the procedure. This aspect may further include the 3-D display to present different steps of the procedure.

This aspect may further include augmented reality of the surgery that may include projected a holography/overlay element, a virtual reality display where representative can manipulate presentation materials in space from a remote location, eye ware-style interface (e.g. Google Glass) and the like. This aspect may further include customization of look and feel (such as font, size, colors, and the like) display using an existing display or a monitor as well as the tablet, and the like. This aspect may further include multiple displays (e.g. iPad +monitor, augmented reality style glasses +monitor, multiple monitors, etc.) to present different steps that are relevant to the procedure to a plurality of users.

Data/communication/analytics/reporting aspects associated with a procedure instruction system as described herein may include security/compliance. This aspect may further include secure communications, secure data storage such as for privacy, and the like. This aspect may further include anonymizer for regulatory compliance, such as a facial obfuscator. This aspect may further include aggregating the data, securing the data, securing the system control (such as voice control security), control over guidance, and the like. This aspect may further include encryption, which may be implemented to support multiple means of encryption and to be configurable.

Data/communication/analytics/reporting aspects associated with a procedure instruction system as described herein may include data that may include patient data such as pre-procedure data, mid-procedure/discovered data, post-procedure data, location data (such as for example, room number, outpatient status, and the like), primary care physician data, and the like. This aspect may further include device data such as electronic IFU, original IFU, and the like. Further, the device may communicate with the OR server while uploading the application to the server or updating an instruction system, providing real-time location guidance and the like. This aspect may further include device data that may include messages such as “I am not fully deployed,” “I am ready,” and the like for establishing communication with the server. This aspect may further include procedure steps modified and/or added by surgeon, and the like. Data associated with the procedural steps may include information from other procedures using the medical device, information from procedures using other medical devices, information from procedures by the steps undertaken by other professionals, information from other procedures by the medical professional, and the like. This aspect may further include data associated with measurable/sensed data/parameters associated with tension, chemical sensors, and the like. This aspect may further include disease/condition data, organ/biological system data, video, animation data, and the like. The animation may include static animations, interactive animations, augmented reality (i.e. mixed animation and video) and the like.

This aspect may further include physiologic data, time spent on procedure, exposure, record of communication with sales rep, and the like. This aspect may further include record of procedure such as time spent, items used, steps taken, and the like. This aspect may further include electronic medical record data for the procedure. This record may become the checklist for the procedure, such as items used, steps taken, and the like. This aspect may further include feedback regarding the procedure, such as what to do to upgrade the quality of the procedure. This aspect may further include a training system with an online community to attain feedback on the procedure. This aspect may use a game engine and scoring to receive the feedback on the procedure. This aspect may further include enabling a community communication facility so that the user may communicate with an online community to receive feedback on the procedure.

This aspect may further include a list of “my procedure,” which may be displayed such as by type, by device, by manufacturer, by hospital, and the like. This aspect may further include aggregate data such as geographic (for example distribution of procedures, trend, compare time spent across a region, and the like), compare with other data (e.g. number of support people), average time per procedure (such as of top doctors, bottom doctors who needs more training, more procedures, who could help train others and speak at conference, and the like), billing information such as cost of equipment required, outcome information, and the like. This aspect may further include integration with other data such as sell data for various sources (sell, market and package the data), EMR data, and the like.

Data/communication/analytics/reporting aspects associated with a procedure instruction system as described herein may include data that may include analytics that may include the data as described herein. This aspect may further include information on device characteristics, on physicians, on procedures, on steps modified and/or added by surgeon, and the like. This aspect may further include information regarding the time required for each step of the procedure, highlighted reversal of steps, and further may include information on which step took more time, and the like. This aspect may further include on graphical view, on data listing view, on practices/hospitals, on specialists supporting procedures, on one or more markets, regarding what creates delays, regarding what creates adverse outcomes, what creates excess costs, what opportunities are being missed, what features are being used or not used, correlations to predict what is going to happen based on the data available, does the device/procedure reduce equipment costs (such as for example, fewer items taken out of the box), ROI and the like.

Parameters associated with a procedure instruction system as described herein may include availability of support specialists for procedures being undertaken.

Methods/processes/algorithms associated with a procedure instruction system as described herein may include analytics and feedback as described herein.

Products associated with a procedure instruction system as described herein may include Instruct-OR system such as described herein.

Features/attributes/benefits associated with a procedure instruction system as described herein may further include a specialist notified as a procedure starts. This aspect may further include a chip embedded in packaging that may initiate instructions when package is opened.

Features/attributes/benefits associated with a procedure instruction system as described herein may further include a specialist informed of type of procedure and current step as voice chat is initiated.

Features/attributes/benefits associated with a procedure instruction system as described herein may further include in-OR training, feedback on best and worst professionals, feedback on areas of improvement, feedback on device characteristics, an open platform (e.g. utilized by multiple manufacturers), real time POC analytics, real time connectivity of a doctor to a sales representative or specialist, voice control, touch screen, voice narration step-by-step, step-by-step guidance, and the like. This aspect may further include branched guidance for the user. The branched guidance may be based on discovered information (e.g. pathology report, change in patient status during the procedure, and the like). The branched guidance may include providing video and/or animation preview to the user such that the user may choose an appropriate branch.

Outputs associated with a procedure instruction system as described herein may further include data and analytics. The output data described herein may include patient data such as pre-procedure data, mid-procedure/discovered data, post-procedure data, location data (such as room number, outpatient status, and the like), primary care physician data, and the like. The output data described herein may include device data that may include an electronic IFU, and/or an original IFU, and the like. Further, the device may communicate with the OR server while uploading the application to the server or updating an instruction system, providing real-time location guidance and the like. This aspect may further include device data that may include messages such as “I am not fully deployed,” “I am ready,” and the like for establishing communication with the server.

The output data described herein may further include procedure steps modified and/or added by surgeon, and the like. Output data described herein may include information from other procedures using the medical device, information from procedures using other medical devices, information from procedures by the steps undertaken by other professionals, information from other procedures by the medical professional, and the like. This aspect may further include data associated with measurable/sensed data/parameters associated with tension, chemical sensors, and the like. This aspect may further include disease/condition data, organ/biological system data, video, animation data, and the like. The animation may include static animations, interactive animations, augmented reality (i.e. mixed animation and video) and the like.

This aspect may further include physiologic data, time spent on procedure, exposure, record of communication with a sales representative or specialist, record of procedure, time spent, items used, steps taken, electronic medical record for procedure (which record may become the checklist of procedure), feedback on procedure (e.g. identifying things to upgrade the quality of the procedure), “my procedures” (which may be displayed, for example, by type, by device, by manufacturer, by hospital), and the like. This aspect may further include a training system with an online community to attain feedback on the procedure. This aspect may use a game engine and scoring to receive the feedback on the procedure. This aspect may further include enabling a community communication facility so that the user may communicate with an online community to receive feedback on the procedure.

This aspect may further include aggregated data such as geographic distribution of procedures, trends, comparing time spent across region, comparing with other data (e.g. the number of support people), average time per procedure, top doctors, bottom doctors, billing information that may include cost of equipment required, outcome information, integration with other data such as sell data for various sources, EMR data, and the like. The analytic outputs described herein may include analytics on device characteristics, on physicians, on procedures, on steps modified and/or added by surgeon, and the like. This aspect may further include information regarding the time required for each step of the procedure, highlighted reversal of steps, and further may include information on which step took more time, and the like. This aspect may further include on graphical view, on data listing view, on practices/hospitals, on specialists supporting procedures, on market, and the like.

Outputs associated with a procedure instruction system as described herein may further include integration with other systems. This aspect of the invention may include integration of hospital IT systems that may include network/server infrastructure, databases, communications systems, scheduling systems, visitor information systems, handoff systems (such as to post-op doctor), billing systems, payer systems. This aspect of the invention may transaction/payment systems, product development/product management systems, and the like.

The features associated with a procedure instruction system as described herein may further include voice activation, procedure selection such as a match or drop-down to show what that doctor is authorized to do.

The interface associated with a procedure instruction system as described herein may include options for device selection, beginning a procedure (such as clock starts), reviewing information off the clock. The interface may also include branding for the manufacturer, the ability to move between steps in a step-by-step procedure using a tab or slide over interface, video/text/animation display, and the like. The text may be displayed by default in the UI or the text may be hidden by default and displayed upon command. The interface may further include a contact physician button, a contact sales representative/specialist button (such as text, call, video chat, and the like) which may also send the sales representative/specialist additional information (e.g. status of the procedure, etc.), a display of the time spent on the step in the procedure, a way to collect feedback (such as to collect information regarding the steps which take much longer than expected) and the like. The feedback may be generated by using the information from other procedures using the medical device, information from procedures using other medical devices, information from procedures by the steps undertaken by other professionals, and information from other procedures by the medical professional.

The features associated with a procedure instruction system as described herein may further include means to capture other feedback. This aspect may further include a way to record verbal comments, such as to record the voice statements. For example, “I like the competitor's device because they have one for left-handed physicians.”

The features associated with a procedure instruction system as described herein may further include a search/find function. This aspect may further include searching/finding types of procedures, manufacturers, “my procedures” (by hospital and by type of procedures), and the like.

Critical supply chain elements associated with a procedure instruction system as described herein may further include materials/inbound components. This aspect may further include step-by-step device and procedure information, such as video, animations, product specifications, images from the manufacturer's IFU, and the like.

Critical supply chain elements associated with a procedure instruction system as described herein may further include hardware such as tablets, networked components (such as servers and databases), and the like.

Critical supply chain elements associated with a procedure instruction system as described herein may further include software and other inputs that may include medical records data, output from other devices (e.g. ultrasounds, MRIs, pathology, etc.) and the like.

Use scenarios and applications associated with a procedure instruction system as described herein may further include real time guidance during a procedure on how to use a medical device. This aspect may further include devices that may include catheter, stent, delivery device (such as port, infusion pump, and the like), retrieval device, implant (such as cochlear, replacement joint, breast, phakic intraocular lenses, and the like), vascular assist device, insulin pump, monitoring device (such as glucose monitor, blood pressure monitor, and the like), imaging device (such as ultrasound and the like), shunt, prosthetic, gastric band, external feeding device, in vitro diagnostics, atherectomy system, pulse generator, anchor system, dental (such as dentures, cap, crown, and the like), and the like. This aspect may further include procedures such as cardiac (such as stent, balloon catheter, valve replacement, shunt, and the like), ablation procedures (such as cryo procedures, urology, harness/mesh, lithotripsy, and the like), neurology, brain, arthroscopy, joint replacement, gynecology, internal medicine, otology, organ replacement, dental, gene therapy, oncology, intubation, turbinoplasty, cosmetic surgery, liposuction, LASIK, and the like.

Use scenarios and applications associated with a procedure instruction system as described herein may further include guide techs and/or nurses through assembly of surgical devices. This may further include trouble-shooting equipment such as generators, lasers, video towers, and the like. This aspect may further include assembling complex sterile equipment. In an example, the procedure instruction system may include a plurality of screens to present different steps that are relevant to the procedure to a plurality of users. Further, this aspect may include kicking-off the next procedure and the plurality of users as per their corresponding steps team in their step-by-step workflow as the prior and in-progress procedure may wrapping up (e.g. circulating nurse for next procedure starts gathering what is needed for the initial steps of the subsequent procedure and the device specialist is queued up to provide support). Use scenarios and applications associated with a procedure instruction system as described herein may further include scheduling of the resources.

Use scenarios and applications associated with a procedure instruction system as described herein may further include parameter measurement/evaluation and feedback during a procedure. This aspect may further include parameters that may include size, configuration, surface characteristics, temperature, appearance, measured parameter (such as for example camera or other inspection fed to person guiding procedure), and the like. This aspect may further include guidance based on feedback such as choice of step, duration of step, omission of step, use/non-use of optional device feature(s), and the like. This aspect may further include the guidance based on information from other procedures using the medical device, information from procedures using other medical devices, information from procedures by the steps undertaken by other professionals, information from other procedures by the medical professional, and the like. This aspect may further include using a Kinect-like camera to monitor motion, location, position, angle, etc. of device to generate feedback to take a corrective action. (e.g. “Your thumb is in the wrong place, move it here;” “the angle of the device is wrong, tilt it this way;” “you are touching the wrong tissue, move this way,” etc.).

Use scenarios and applications associated with a procedure instruction system as described herein may further include use in clinical trials. This aspect may further include enrollment criteria.

Use scenarios and applications associated with a procedure instruction system as described herein may further include market data collection. This aspect may further include embedded questions and may collect data such as for return on investment analysis by the device manufacturer. The embed questions may present marketing questions at the right time (during the waiting time or down time during a procedure). The questions described herein may be for example “Would you like to answer a survey question while you wait?” The surgeons may be paid upon answering the questions. This aspect may further include time at the scrub sink (for example for displaying digital ads during identified waiting times).

Use scenarios and applications associated with a procedure instruction system as described herein may further include sandbox/training. This aspect may further include separate use case for learning a procedure offline. This aspect may further include separate use case for learning in a lab such as simulation lab, cadaver lab, and the like.

Use scenarios and applications associated with a procedure instruction system as described herein may further include tracking and analysis of activities to enable improvement of a medical procedure. This aspect may further include improvement of a medical device. The improvement of the medical device may be achieved by tracking and analyzing the activities such as what steps take longest, what features are most difficult to use, what features fail/produce non-optimal results, what features do surgeons prefer or dislike, what steps in the procedure are modified/skipped and/or added by surgeons, and the like. This aspect may further include improvement of a surgeon. The improvement of a surgeon may be achieved by tracking and analyzing the activities such as how long does a surgeon take relative to norm for a step, what training could improve the surgeon's performance, and the like. This aspect may further include improvement of a procedure. The improvement of a procedure may be achieved by tracking and analyzing the activities such as what steps in a procedure take too long, what steps lead to poor outcomes, what steps in the procedure are modified, skipped and/or added by surgeons, and the like.

Use scenarios and applications associated with a procedure instruction system as described herein may further include Instruct-OR use over the lifecycle of a device. This aspect may further include use scenarios include steps such as sales representative and/or specialist training, sales representative and/or specialist demonstrations and walk throughs with practitioners, surgeon downloads and walks through the steps and practices, and cadaver lab run through of the procedure such as with the rep analytics and the like. The aspect may further include use in the OR for a live procedure such as during a preparation at a scrub sink, during a timeout in the procedure, during the procedure, and the like. This aspect may further include a post-OR debrief. This aspect may further include analytics on the surgeon, the procedure, and the like. This aspect may further include providing feedback on the device to the manufacturer.

Markets associated with a procedure instruction system as described herein may further include medical devices such as surgery and other market areas.

Methods and systems described herein are generally applicable for on-site, situational training and guidance. Instructor-OR use of medical devices is one, non-limiting embodiment. Environments of deployment associated with a procedure instruction system as described herein may further include an operating room (which may include remote assistance), an emergency room, interventional cardiology, interventional radiology, GI procedure suite, a post-anesthesia care unit, an intensive care unit, a CT suite, a MRI suite, a scrub station (which may be a separate system for preparing at scrub station), a learning lab (such as simulation lab, cadaver lab, and the like), a doctor's office, a hospital bedside, and the like. Instruct-OR may be used in veterinary medicine applications and/or operations. Instruct-OR may also be used for non-medical situational training and guidance. In one example, Instruct-OR may be used by an auto-mechanic in an auto repair center servicing an automobile. In another example, Instruct-OR may be used by an Information Technology administrator in a server farm to install new hardware and/or software. In another example, a system as described herein may be used to guide activities within a food preparation environment, such as for cooking References throughout this disclosure to an operating room or other medical environment should be understood to refer optionally, where context is appropriate, to non-medical environments where remote guidance or instructions may be useful, as well as other environments where step-by-step procedures may take place. Similarly, references to medical devices should be understood to refer optionally to non-medical devices, and references to a doctor, health care professional, or medical device specialist should be understood optionally to encompass, as context permits, other individuals who may complete steps of non-medical procedures or provide guidance in connection with non-medical procedures. Also, references to a patient or medical subject may be understood, optionally as context permits, to refer to other animate or inanimate subjects or objects upon which or with respect to which procedures may be undertaken, such as physical work-pieces, mechanical systems, information technology systems, items of digital content, ingredients or materials used in food preparation, or the like.

The ecosystem/value chain associated with a procedure instruction system as described herein may further include various entities that may use, or benefit from the use of such a system, including, without limitation, hospitals/practices, schools (such as medical schools, nursing schools, and the like), physicians, medical students/interns, manufacturers (such as sales representatives, support specialists, and the like), insurers, hosts, and big data/analytics companies.

A procedure instruction system as described herein may further include integration/interaction with various other systems, such as information technology systems, networks, data storage facilities, and the like, including established healthcare IT systems. This aspect may further include billing systems such as to export a checklist from the procedure exported to the billing system. The billing system described herein may receive the checklists of items used that may be billed. This aspect may further include manufacturer systems such as to track that a device was opened or being used. This aspect may further include inventory management systems. The inventory management systems may be used to track where the product is located (e.g. on consignment), to avoid paper-based logistics, and the like. This aspect may further include training/simulation/QA systems, scheduling systems, purchasing systems, analytic systems, EMR systems, and the like.

The systems integration/relationship associated with a procedure instruction system as described herein may further include manufacturer systems.

The systems integration/relationship associated with a procedure instruction system as described herein may further include insurance/reimbursement.

The systems integration/relationship associated with a procedure instruction system as described herein may further include regulatory bodies.

The competitive strategy associated with a procedure instruction system as described herein may further include competing technologies, alternative technologies, and the like.

The corporate development associated with a procedure instruction system as described herein may further include value proposition for acquisition, new market entry, licensing/OEM, and the like. OEM/licensing may include corporate such as IBM (a licensor of medical record data-related tech language translation), Smith and Nephew and the like. In speech recognition, OEM/licensing may include corporations such as may be Dragon, Apple, Microsoft, IBM and the like. In sensors, OEM/licensing may include Sensory, Novaris, IndoSpeech and the like.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed:

1. An analytic system for analyzing a medical procedure performed on a patient, the system comprising:
an information communication facility to receive time-stamped information relating to each of a plurality of steps of the medical procedure performed by a medical practitioner; and
a data analyzer facility to associate the time-stamped information relating to the steps of the medical procedure with data associated with at least one of: an outcome of the procedure and a duration of the steps compared to other practitioners who performed a medical procedure, the data analyzer facility providing analytic data regarding at least one of the medical practitioner; a medical procedure, a desired workflow for the medical procedure, and a medical device associated with the medical procedure.

2. The system of claim 1, wherein the information communication facility allows a user to provide specific feedback relating to the performed medical procedure, and wherein the data analyzer facility incorporates the specific feedback in the analytic data provided.

3. The system of claim 2, wherein the user is at least one of a medical practitioner and an operation supervisor of the medical procedure.

4. The system of claim 1, wherein the data analyzer facility is further enabled to associate the time-stamped information with each step of a standard workflow of the medical procedure.

5. The system of claim 1, wherein the analytic data includes data to improve at least one of the medical procedure, a medical device associated with the medical procedure, and a desired workflow for the medical procedure.

6. The system of claim 1, wherein the information communication facility comprises:
an information logging facility to log time-stamped information relating to each step of a medical procedure performed by the medical practitioner, the medical procedure including use of a medical device;
and wherein the data analyzer facility comprises a procedure information comparison facility to compare the time-stamped information with at least one of:
information from another medical procedure using the medical device, information from another medical procedure using another medical device,
information from another medical procedure undertaken by another medical practitioner, and
information from another procedure by the medical practitioner; and
a feedback generating facility to, based on the comparison of the information, provide feedback to at least one of the manufacturer of the medical device, the manager of the medical procedure, and the medical practitioner.

7. The system of claim 6, wherein the feedback to the medical practitioner includes the total procedure time.

8. The system of claim 7, wherein the feedback to the medical practitioner includes the time for each step of the procedure.

9. A medical device tracking system, comprising:
a plurality of tracked medical devices, each medical device including a packaging and an associated tracking communication facility to detect when a condition of the packaging of the medical device has changed;
a device tracking facility in communication with each medical device for receiving a communication from an associated tracking communication facility when a condition of the packaging of that medical device has changed.

10. The medical device tracking system of claim 9, wherein the tracking communication facility determines when the packaging of the medical device is at least one of opened and moved.

11. The system of claim 10, wherein the device tracking facility is further enabled to start a workflow of medical procedure in response to receiving a communication from a tracked medical device.

12. A privacy system, comprising:
a video capture facility to encode and decode live video relating to a medical procedure performed by a medical practitioner;
an obfuscation facility to modify the live video by obfuscating a person's identity; and
an obfuscated video communication facility to communicate the modified live video in an instructional system.

13. The system of claim 12, wherein the person is a patient.

14. The system of claim 12, wherein the modified live video is HIPAA compliant.
